(19) United States
(12) Patent Application Publication
(10) Pub. No.: US 2018/0072104 A1
(43) Pub. Date: Mar. 15, 2018

(54) TIRE TREAD FEATURING A SIPE

(71) Applicant: Bridgestone Americas Tire Operations, LLC, Nashville, TN (US)

(72) Inventors: Jie Jin, Copley, OH (US); Cory Williams, Medina, OH (US); Joseph Woodward, Akron, OH (US)

(21) Appl. No.: 15/818,721

(22) Filed: Nov. 20, 2017

Related U.S. Application Data
(63) Continuation-in-part of application No. 14/618,611, filed on Feb. 10, 2015, now abandoned.
(60) Provisional application No. 61/949,309, filed on Mar. 7, 2014.

(51) Int. Cl. B60C 11/12

(52) U.S. Cl. CPC B60C 11/1218; B60C 2011/1213; B60C 11/1204

(57) ABSTRACT

Various embodiments of a tire tread having at least one sipe comprising an S-shaped geometry are disclosed. In one embodiment, a tire is provided, comprising: a tread portion comprising tread block or tread rib; the tread block or the tread rib having at least one sipe, wherein the at least one sipe includes at least one convex portion and at least one concave portion forming an S-shaped geometry along at least a portion of a length of the sipe, wherein the S-shaped geometry along at least a portion of the length of the sipe has an amplitude (A1), and wherein the amplitude (A1) varies along a radial height of the sipe, and wherein the at least one sipe includes a first curvilinear portion and a second curvilinear portion oriented substantially radially within the sipe, and forming an S-shaped geometry along the radial height of the sipe.

### CROSS-REFERENCE TO RELATED APPLICATIONS

This application claims priority as a continuation-in-part application to U.S. patent application Ser. No. 14/618,611, filed on Feb. 10, 2015, which claims priority to U.S. Patent Application No. 61/949,309, filed on Mar. 7, 2014, each of which is incorporated by reference herein in its entirety.

### BACKGROUND

Tires, including off-road radial (“ORR”) tires, may comprise a tread featuring sipes. The presence of sipes in a tire tread may create more surface edges to engage a roadway, which may increase traction in adverse road conditions. For example, a tire tread including sipes may perform better in icy road conditions than a tire tread not including sipes.

However, the addition of sipes to a tire tread block may reduce block stiffness, which may result in undesirable irregular wear patterns in the tire. Additionally, a tire tread featuring sipes may undesirably capture stones in the sipes. Stones caught in a tire tread's sipes may reduce the effectiveness of the tire tread in increasing traction, may damage the tire or tire tread, may cause irregular wear patterns in the tire, and may create a safety hazard if the stones are ejected as the tire travels down a roadway.

What is needed is a tire tread block featuring sipes configured to reduce irregular wear and capturing of stones.

### SUMMARY

In one embodiment, a tire is provided, the tire comprising: a tread portion comprising at least one of a tread block and a tread rib; at least one of the tread block and the tread rib having at least one sipe, wherein the at least one sipe includes at least one convex portion and at least one concave portion forming an S-shaped geometry along at least a portion of a length of the sipe, wherein the S-shaped geometry along at least a portion of the length of the sipe has an amplitude (A1), and wherein the amplitude (A1) varies along a radial height of the sipe, and wherein the at least one sipe includes a first curvilinear portion and a second curvilinear portion oriented substantially radially within the sipe, and forming an S-shaped geometry along the radial height of the sipe.

In another embodiment, a tire is provided, the tire comprising: a tread portion comprising at least one of a tread block and a tread rib; at least one of the tread block and the tread rib having at least one sipe, wherein the at least one sipe includes at least one convex portion and at least one concave portion forming an S-shaped geometry along at least a portion of a length of the sipe, wherein the S-shaped geometry along at least a portion of the length of the sipe has an amplitude (A1), wherein the at least one convex portion has a half-wavelength (F4) and wherein the at least one concave portion has a half-wavelength (F5), and wherein the half-wavelength (F4) of the at least one convex portion and the half-wavelength (F5) of the at least one concave portion vary along a radial height of the sipe, and wherein the at least one sipe includes a first curvilinear portion and a second curvilinear portion oriented substantially radially within the sipe, and forming an S-shaped geometry along the radial height of the sipe.

In another embodiment, a tire is provided, the tire comprising: a tread portion comprising at least one of a tread block and a tread rib; at least one of the tread block and the tread rib having at least one sipe, wherein the at least one sipe includes a first curvilinear portion and a second curvilinear portion oriented substantially radially within the sipe, and forming an S-shaped geometry along the radial height of the sipe, wherein the S-shaped geometry along the radial height of the sipe has an amplitude (A2), and wherein the amplitude (A2) decreases as the sipe extends radially inwardly into the tread portion, and wherein the amplitude (A2) of the S-shaped geometry along the radial height of the sipe decreases in value at a ratio of between about 1:12 and about 1:6 of a distance that the sipe extends radially inwardly into the tread portion.

### BRIEF DESCRIPTION OF THE DRAWINGS

The accompanying figures, which are incorporated in and constitute a part of the specification, illustrate various example configurations, and are used merely to illustrate various example embodiments. In the figures, like elements bear like reference numerals.

FIG. 1 illustrates a top plan view of an example embodiment of a tire tread block having a sipe featuring an S-shaped geometry.

FIG. 2 illustrates a side elevational view of an example embodiment of a tire tread block having a sipe featuring an S-shaped geometry.

FIG. 3A illustrates a side elevational view of an example embodiment of a tire tread block having a sipe featuring an S-shaped geometry.

FIG. 3B illustrates a schematic of a sectional view of an example embodiment of a tire tread block sipe featuring an S-shaped geometry.

FIG. 4 illustrates a perspective view of an example embodiment of a tire tread block having a sipe featuring an S-shaped geometry.

FIG. 5 illustrates a plan view of an example embodiment of a tire tread block having a sipe featuring an S-shaped geometry.

FIG. 6A illustrates a perspective view of an example embodiment of a tire sipe blade for forming a sipe featuring an S-shaped geometry.

FIG. 6B illustrates a side elevational view of an example embodiment of a tire sipe blade for forming a sipe featuring an S-shaped geometry.

FIG. 6C illustrates a top plan view of an example embodiment of a tire sipe blade for forming a sipe featuring an S-shaped geometry.

FIG. 7A illustrates a top plan view of an example embodiment of a tire tread block having a sipe featuring a variable S-shaped geometry.

FIG. 7B illustrates a side elevational view of an example embodiment of a tire tread block having a sipe featuring a variable S-shaped geometry.

FIG. 7C illustrates a sectional view of an example embodiment of a tire tread block having a sipe featuring a variable S-shaped geometry.

FIG. 7D illustrates a side elevational view of an example embodiment of a tire tread block having a sipe featuring a variable S-shaped geometry.

FIG. 7E illustrates a sectional view of an example embodiment of a tire tread block having a sipe featuring a variable S-shaped geometry.

FIG. 7F illustrates a side elevational view of an example embodiment of a tire tread block having a sipe featuring a variable S-shaped geometry.

FIG. 7G illustrates a sectional view of an example embodiment of a tire tread block having a sipe featuring a variable S-shaped geometry.

FIG. 7H illustrates a side elevational view of an example embodiment of a tire tread block having a sipe featuring a variable S-shaped geometry.

FIG. 7I illustrates a schematic of a sectional view of an example embodiment of a tire tread block sipe featuring a variable S-shaped geometry.

FIG. 8A illustrates a top plan view of an example embodiment of a tire tread block having a sipe featuring a variable S-shaped geometry.

FIG. 8B illustrates a side elevational view of an example embodiment of a tire tread block having a sipe featuring a variable S-shaped geometry.

FIG. 8C illustrates a sectional view of an example embodiment of a tire tread block having a sipe featuring a variable S-shaped geometry.

FIG. 8D illustrates a side elevational view of an example embodiment of a tire tread block having a sipe featuring a variable S-shaped geometry.

FIG. 8E illustrates a sectional view of an example embodiment of a tire tread block having a sipe featuring a variable S-shaped geometry.

FIG. 8F illustrates a side elevational view of an example embodiment of a tire tread block having a sipe featuring a variable S-shaped geometry.

FIG. 8G illustrates a schematic of a sectional view of an example embodiment of a tire tread block sipe featuring a variable S-shaped geometry.

FIG. 9 illustrates a perspective view of an example embodiment of a tire tread block having a sipe featuring a variable S-shaped geometry.

FIG. 10 illustrates a plan view of an example embodiment of a tire tread block having a sipe featuring a variable S-shaped geometry.

FIG. 11A illustrates a perspective view of an example embodiment of a tire sipe blade for forming a sipe featuring a variable S-shaped geometry.

FIG. 11B illustrates a side elevational view of an example embodiment of a tire sipe blade for forming a sipe featuring a variable S-shaped geometry.

FIG. 11C illustrates a top plan view of an example embodiment of a tire sipe blade for forming a sipe featuring a variable S-shaped geometry.

FIG. 12 illustrates a side elevational view of an example embodiment of a tire tread block having a sipe featuring a variable S-shaped geometry.

FIG. 13 illustrates a side elevational view of an example embodiment of a tire tread block having a sipe featuring a variable S-shaped geometry.

FIG. 14 illustrates a side elevational view of an example embodiment of a tire tread block having a sipe featuring a variable S-shaped geometry.

### DETAILED DESCRIPTION

Tires not intended for operation on smooth, dry surfaces typically comprise a tread pattern, including a least one groove, at least one rib, and/or a plurality of tread blocks. Tires intended for operation in inclement conditions, including for example icy or snowy conditions, may additionally comprise a plurality of sipes in the tire tread. The addition of sipes in the tire tread may result in more surface edges in the tire tread for engagement with the icy or snowy roadway.

If one or more tire is mounted on a vehicle, the entire weight of the vehicle, and the one or more tire, is supported by the contact patch of the one or more tire. A tire's contact patch is that portion of the tire in contact with a roadway or other surface supporting the vehicle at any given instant in time. Many tires, including for example ORR tires, may be used on heavy vehicles and thus may experience great pressures and forces in the contact patch's interface with the roadway.

Stones or other debris encountered between the tire's contact patch and the roadway can be forced into the tire's tread with great force. In a tire tread comprising sipes, stones or other debris may be lodged in the sipe, thus reducing the sipe's effectiveness at increasing traction, causing damage to the tire or tire tread, causing irregular wear, and/or creating a safety hazard should the stone or other debris be ejected during tire operation.

Traditional sipes comprise substantially radially-oriented, narrow slits extending from a tread surface into the tread. These traditional sipes typically include straight, parallel walls, providing a stone or other debris easy access to the void created by the sipe. In some instances, a stone or other debris can become lodged within the sipe in such a manner so as to affect the stiffness of a tread block or rib containing the sipe, resulting in irregular wear or damage to the tire tread.

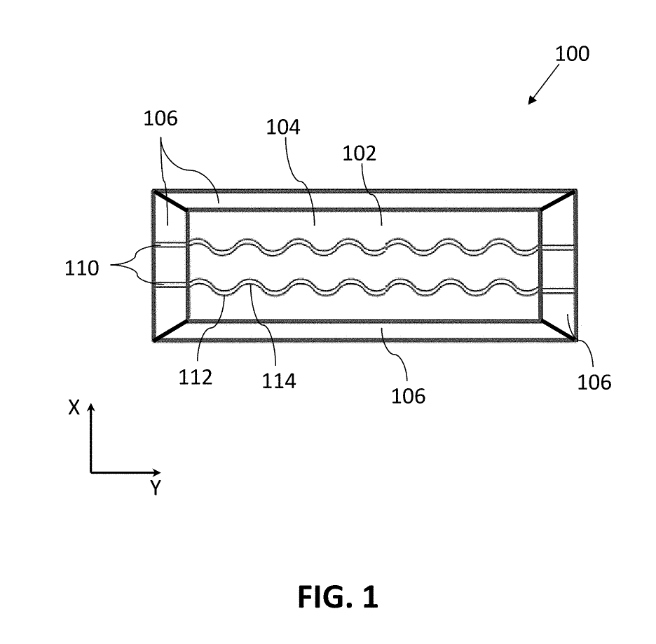

FIG. 1 illustrates a top plan view of an example embodiment of a tire tread 100. Tread 100 may comprise a tread block 102. Tread block 102 may comprise a ground-contacting surface 104 and at least one side surface 106.

In one embodiment, tread 100 comprises at least one of tread block 102, and a tread rib (not shown). Tread 100 may comprise a combination of tread blocks 102 and at least one tread rib (not shown). At least one tread rib (not shown) may be oriented substantially circumferentially about tire tread 100 (i.e., substantially parallel to the X-axis). It is understood that various references to a tread block herein may additionally refer to a tread rib in that the various sipes illustrated in a tread block herein may also be applied to a tread rib. Tread blocks and tread ribs described herein may be collectively referred to as a tread portion.

In one embodiment, tread block 102 is oriented such that it comprises a longer dimension (L1/L2) oriented in an axial direction (i.e., substantially parallel to Y-axis). Tread block 102 may be oriented such that it comprises a longer dimension (L1/L2) oriented in a circumferential direction (i.e., substantially parallel to X-axis). Tread block 102 may be oriented at an angle relative to the axial direction or the circumferential direction.

Tread block 102 may comprise at least one sipe 110. At least one sipe 110 may be oriented substantially axially (i.e., substantially parallel to the Y-axis), substantially circumferentially (i.e., substantially parallel to the X-axis), and/or inclined at an angle relative to either the X-axis or the Y-axis. At least one sipe 110 may include a plurality of sipes oriented substantially parallel to one another. At least one sipe 110 may include a plurality of sipes inclined at an angle relative to one another.

At least one sipe 110 may comprise an S-shaped geometry. In one embodiment, sipe 100 may comprise a plurality of alternating convex portions 112 and concave portions 114 (relative to at least one side surface 106). Convex portions 112 and concave portions 114 may be oriented as illustrated in FIG. 1 so as to form a continuous S-shaped geometry along at least a portion of the length of sipe 110.

The S-shaped geometry of sipe 110 may extend all the way to at least one side surface 106. Sipe 110 may intersect at least one side surface 106 with a substantially straight geometry portion (not shown), which intersects at least one of convex portion 112 and concave portion 114, such that the S-shaped geometry does not extend to side surface 106. In one embodiment, sipe 110 may not extend to any side surface 106, such that sipe 110 is contained within an interior portion of ground-contacting surface 104.

In one embodiment, sipe 110 may comprise a S-shaped geometry similar to a sinusoidal curve. The amplitude of the curve in sipe 110 may be constant along the length of sipe 110. The amplitude of the curve in sipe 110 may alternatively vary along the length of sipe 110. In one embodiment, the wavelength of the curve in sipe 110 may be constant along the length of sipe 110. The wavelength of the curve in sipe 110 may alternatively vary along the length of sipe 110. In one embodiment, a plurality of sipes 110 may be contained within tread block 102 or tread rib (not shown), and the curves of sipes 110 may be in phase with one another. Alternatively, the curves of sipes 110 may be out of phase with one another.

Tread block 102 may comprise a length and a width. Tread block 102 may comprise a tapered orientation, such that ground-contacting surface 104 has a smaller area than a base of tread block 102. Tread block 102 may comprise any of a variety of cross-sections, including a substantially rectangular cross-section, a substantially square cross-section, a substantially triangular cross-section, a substantially trapezoidal cross-section, or a cross-section substantially similar to any regular or irregular shape.

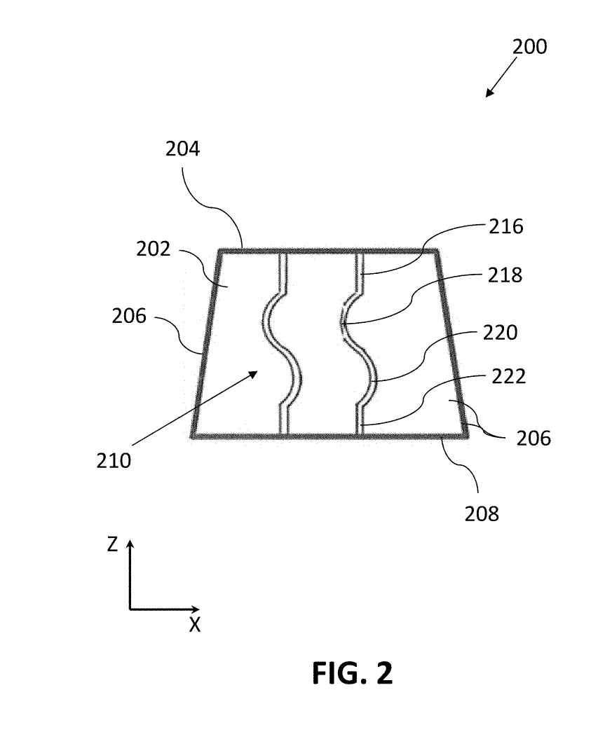

FIG. 2 illustrates a side elevational view of an example embodiment of a tire tread 200. Tread 200 may comprise a tread block 202. Tread block 202 may comprise a ground-contacting surface 204, at least one side surface 206, and a base 208.

In one embodiment, tread 200 comprises at least one of tread block 202, and a tread rib (not shown).

Tread block 202 may comprise at least one sipe 210. At least one sipe 210 may open to at least one side surface 206. In one embodiment, at least one sipe 210 may not open to any side surface 206.

At least one sipe 210 may comprise an upper vertical section 216 in communication with ground-contacting surface 204. Upper vertical section 216 may comprise a sipe section substantially parallel to the Z-axis. In one embodiment, upper vertical section 216 may be inclined relative to the Z-axis. In one embodiment, upper vertical section 216 is substantially coplanar with a YZ-plane. In one embodiment, upper vertical section 216 is inclined at an angle relative to a YZ-plane.

At least one sipe 210 may comprise a first curvilinear portion 218. At least one sipe 210 may comprise a second curvilinear portion 220. First curvilinear portion 218 and second curvilinear portion 220 may be oriented so as to form an S-shaped geometry. In one embodiment, at least one sipe 210 comprises additional curvilinear portions (not shown) oriented relative to first curvilinear portion 218 and second curvilinear portion 220 so as to form an extended S-shaped geometry.

In one embodiment, first curvilinear portion 218 may communicate with ground-contacting surface directly. In one embodiment, second curvilinear portion 220 may communicate with base 208 directly. Additional curvilinear portions (not shown) may communicate with ground contacting portion 204, base 208, upper vertical section 216, and/or a lower vertical section 222.

At least one sipe 210 may comprise lower vertical section 222. Lower vertical section 222 may contact base 208. Lower vertical section 222 may comprise a sipe section substantially parallel to the Z-axis. In one embodiment, lower vertical section 222 may be inclined relative to the Z-axis. In one embodiment, lower vertical section 222 is substantially coplanar with a YZ-plane. In one embodiment, lower vertical section 222 is inclined at an angle relative to a YZ-plane. In one embodiment, upper vertical section 216 and lower vertical section 222 are substantially parallel. In another embodiment, upper vertical section 216 and lower vertical section 222 are substantially coplanar.

In one embodiment, first curvilinear portion 218 and second curvilinear portion 220 of sipe 210 may comprise a S-shaped geometry similar to a sinusoidal curve. The amplitude of the curve in sipe 210 may be constant along the height of sipe 210. The amplitude of the curve in sipe 210 may alternatively vary along the height of sipe 210. In one embodiment, the wavelength of the curve in sipe 210 may be constant along the height of sipe 210. The wavelength of the curve in sipe 210 may alternatively vary along the height of sipe 210. In one embodiment, a plurality of sipes 210 may be contained within tread block 202 or tread rib (not shown), and the curves of sipes 210 may be in phase with one another. Alternatively, the curves of sipes 210 may be out of phase with one another.

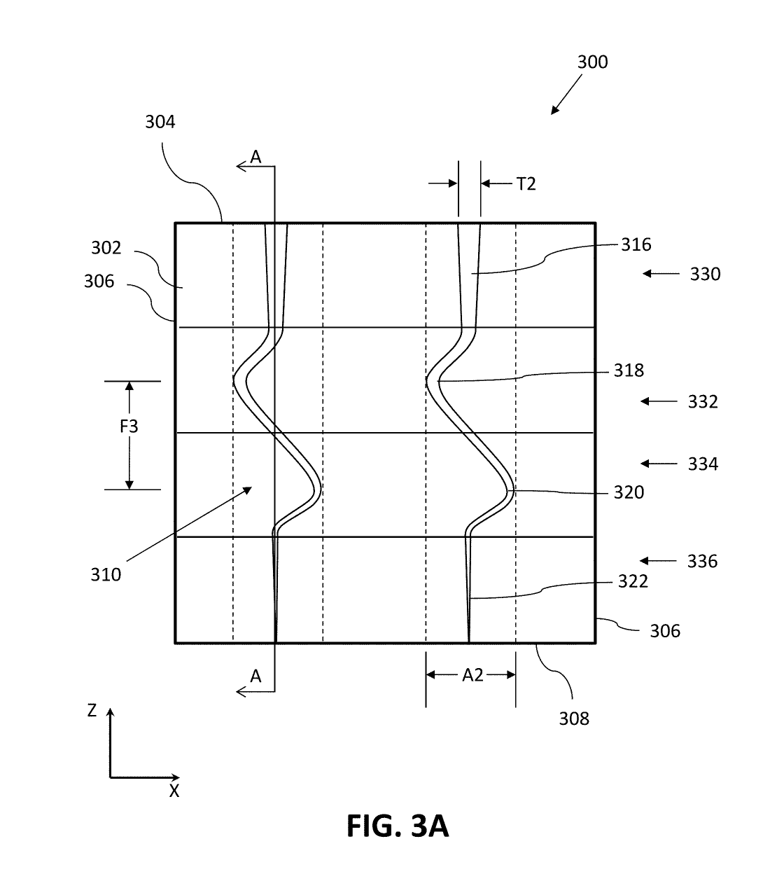

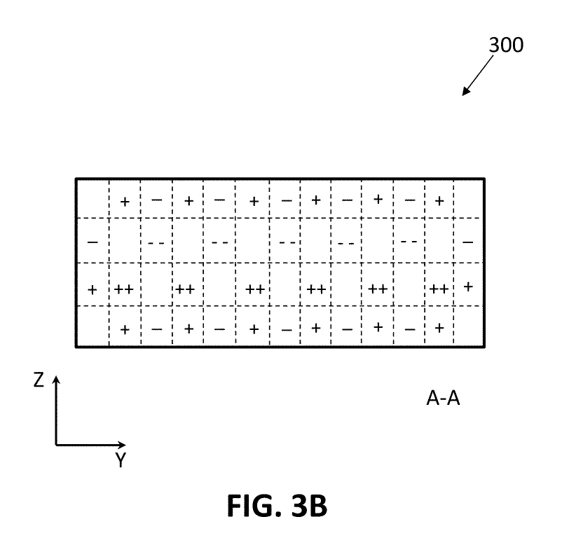

FIG. 3A illustrates a side elevational view of an example embodiment of a tire tread 300. Tread 300 may comprise a tread block 302. Tread block 302 may comprise a ground-contacting surface 304, at least one side surface 306, and a base 308.

Tread block 302 may comprise at least one sipe 310. At least one sipe 310 may open to at least one side surface 306. In one embodiment, at least one sipe 310 may not open to any side surface 306.

At least one sipe 310 may comprise an upper vertical section 316 in communication with ground-contacting surface 304. Upper vertical section 316 may comprise a sipe section substantially parallel to the Z-axis. In one embodiment, upper vertical section 316 may be inclined relative to the Z-axis. In one embodiment, upper vertical section 316 is substantially coplanar with a YZ-plane. In one embodiment, upper vertical section 316 is inclined at an angle relative to a YZ-plane.

At least one sipe 310 may comprise a first curvilinear portion 318. At least one sipe 310 may comprise a second curvilinear portion 320. First curvilinear portion 318 and second curvilinear portion 320 may be oriented so as to form an S-shaped geometry. In one embodiment, at least one sipe 310 comprises additional curvilinear portions (not shown) oriented relative to first curvilinear portion 318 and second curvilinear portion 320 so as to form an extended S-shaped geometry.

In one embodiment, first curvilinear portion 318 may communicate with ground-contacting surface directly. In one embodiment, second curvilinear portion 320 may communicate with base 308 directly. Additional curvilinear portions (not shown) may communicate with ground contacting portion 304, base 308, upper vertical section 316, and/or a lower vertical section 322.

At least one sipe 310 may comprise lower vertical section 322. Lower vertical section 322 may contact base 308. Lower vertical section 322 may comprise a sipe section substantially parallel to the Z-axis. In one embodiment, lower vertical section 322 may be inclined relative to the Z-axis. In one embodiment, lower vertical section 322 is substantially coplanar with a YZ-plane. In one embodiment, lower vertical section 322 is inclined at an angle relative to a YZ-plane. In one embodiment, upper vertical section 316 and lower vertical section 322 are substantially parallel. In another embodiment, upper vertical section 316 and lower vertical section 322 are substantially coplanar.

In one embodiment, first curvilinear portion 318 and second curvilinear portion 320 of sipe 310 may comprise a S-shaped geometry similar to a sinusoidal curve. The amplitude A2 of the curve in sipe 310 may be constant along the height of sipe 310. The amplitude A2 of the curve in sipe 310 may alternatively vary along the height of sipe 310. In one embodiment, the wavelength F3 of the curve in sipe 310 may be constant along the height of sipe 310. The wavelength F3 of the curve in sipe 310 may alternatively vary along the height of sipe 310. In one embodiment, a plurality of sipes 310 may be contained within tread block 302 or tread rib (not shown), and the curves of sipes 310 may be in phase with one another. Alternatively, the curves of sipes 310 may be out of phase with one another.

Sipe 310 may have a thickness T2. Thickness T2 may be defined as the distance between sipe sidewalls bounding sipe 310, measured perpendicular to tangent lines taken at a radial height (measured along the Z-axis). Stated differently, thickness T2 is the thickness of sipe 310 across sipe 310, regardless of the angle of sipe 310 at the point of measurement.

Sipe 310 may have a constant thickness T2 along its radial height. Alternatively, sipe 310 may have a variable thickness T2 along its radial height. Sipe 310 may have a variable thickness T2 that decreases as sipe 310 extends from ground-contacting surface 304 to or toward base 308.

As illustrated in FIG. 3A sipe 310 may have a variable thickness T2 decreasing along its entire radial height (from ground-contacting surface 304 to or toward base 308). Alternatively, sipe 310 may have a variable thickness T2 increasing along its entire radial height (from ground-contacting surface 304 to or toward base 308). Alternatively, sipe 310 may have a variable thickness T2 along one or more portion of sipe 310's radial height and a constant thickness T2 along one or more portion of sipe 310's radial height. For example, sipe 310 may have a variable thickness T2 in upper vertical section 316 and a constant thickness T2 in the remainder of sipe 310's radial height. In another example, sipe 310 may have a constant thickness T2 in upper vertical section 316 and a variable thickness T2 in the remainder of sipe 310's radial height. It is understood that any section (radially) of sipe 310 may have a constant thickness T2 or variable thickness T2. Sipe 310 may have a thickness T2 that is constant, or variable, in the XZ-plane.

Sipe 310 may have a variable thickness T2 decreasing or increasing at a constant rate, variable rate, or a combination thereof. For example, sipe 310 may have a thickness T2 of about 2.0 mm at ground-contacting surface 304), a thickness T2 of about 1.0 mm at one half of sipe 310's radial height, and may decrease to a thickness T2 of about 0.0 mm at sipe 310's radially innermost portion (illustrated in FIG. 3A at about base 308, but being understood that sipe 310 may have a radially innermost portion 308 at a point radially inward or radially outward of base 308).

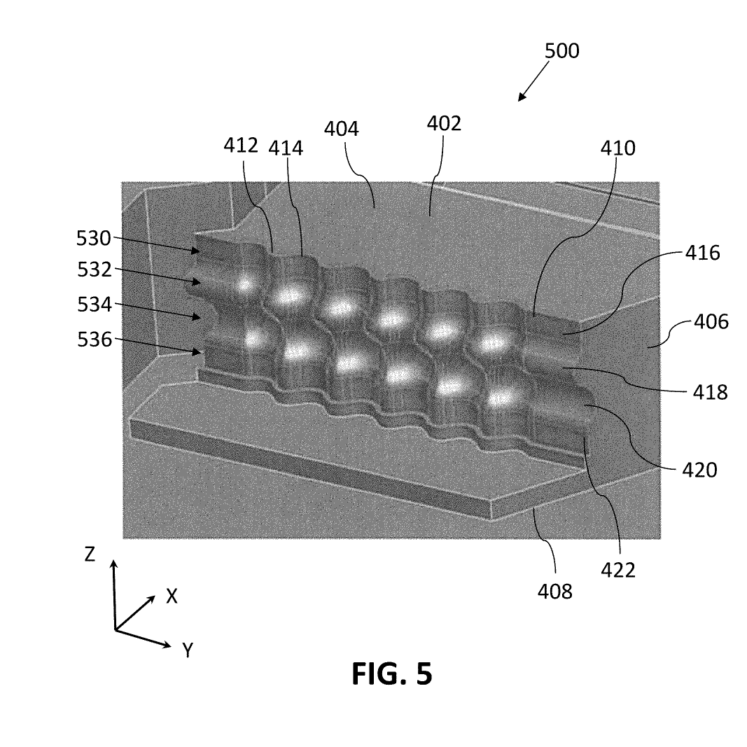

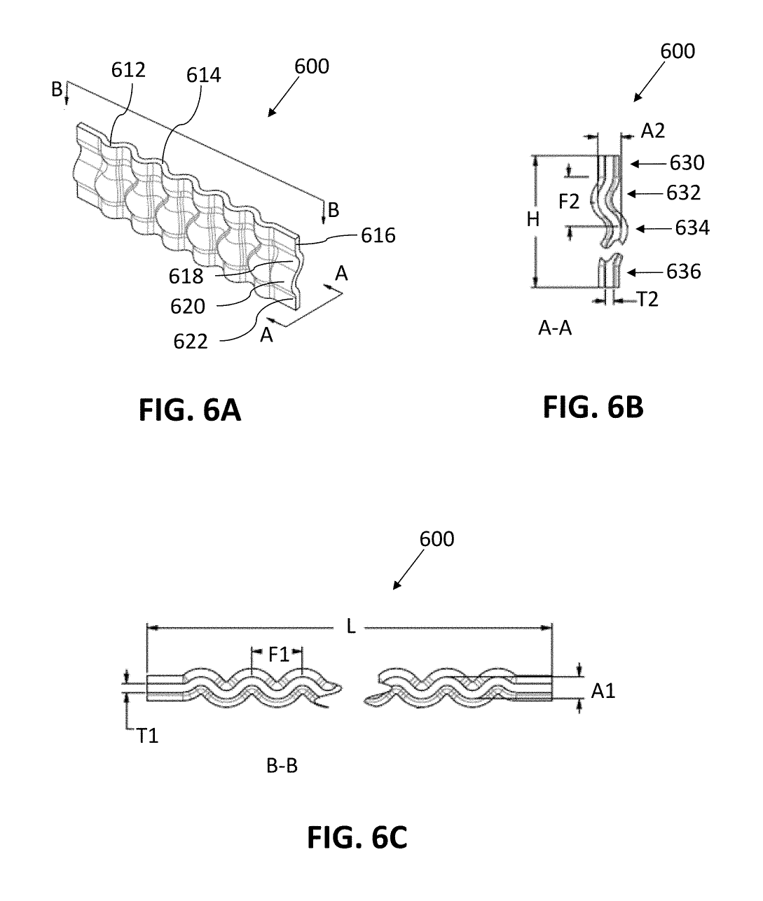

FIG. 3B illustrates a schematic of a sectional view of an example embodiment of a tire tread 300 featuring an S-shaped geometry taken from A-A in FIG. 3A. Independent blocks (represented by rectangles) generally represent sections of sipe 310 (illustrated as sipe 410 in FIG. 5) divided by sipe 310 crossing a central plane extending along the length of sipe 310 and parallel to or coplanar with the YZ-plane. Blocks containing a “+” symbol indicate a portion of sipe 310 that is convex, or extending out of the page. Blocks containing a “−” symbol indicate a portion of sipe 310 that is concave, or extending into the page. Blocks containing a “++” symbol indicate a portion of sipe 310 that is convex, and extending a greater distance out of the page than those blocks containing a “+” symbol. Blocks containing a “−−” symbol indicate a portion of sipe 310 that is concave, and extending a greater distance into the page than those blocks containing a “−” symbol. Blocks containing no symbol indicate a portion of sipe 310 falling on or near a central plane extending along the length of sipe 310 and parallel to or coplanar with the YZ-plane. FIG. 3B may be a schematic representation of sipe formed by sipe blade 600 illustrated in FIG. 6A, which may appear similar to sipe 410 illustrated in FIG. 5.

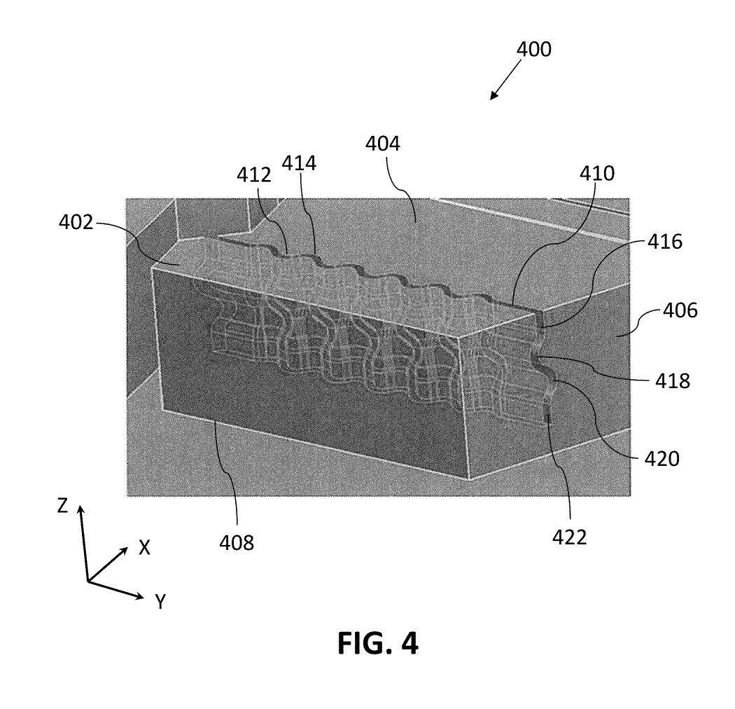

FIG. 4 illustrates a perspective view of an example embodiment of a tire tread 400. Tire tread 400 may comprise a tread block 402. Tread block 402 may comprise a ground-contacting surface 404, at least one side surface 406, and a base 408.

Tread block 402, or a tread rib (not shown) may comprise at least one sipe 410. At least one sipe 410 may comprise at least one convex portion 412 and at least one concave portion 414. In one embodiment, sipe 410 comprises alternating convex portions 412 and concave portions 414 forming an S-shaped geometry in a plane substantially parallel to an XY-plane.

At least one sipe 410 may comprise an upper vertical section 416, a first curvilinear portion 418, a second curvilinear portion 420, and a lower vertical section 422. First curvilinear portion 418 and second curvilinear portion 420 may form an S-shaped geometry in a plane substantially parallel to an XZ-plane.

As illustrated in FIG. 4, at least one sipe 410 may comprise an S-shaped geometry in each of an XY-plane and an XZ-plane. In another embodiment, at least one sipe 410 may comprise an S-shaped geometry in at least one of an XY-plane and an XZ-plane. In another embodiment, at least one sipe 410 may comprise an S-shaped geometry in at least two of an XY-plane, an XZ-plane, and a YZ-plane.

In one embodiment, the S-shaped geometry within sipe 410 creates a series of protrusions and indentations configured to engage one another and increase stiffness of tread block 402 or a tread rib (not shown). Increased stiffness of tread block 402 or a tread rib (not shown) may prevent, mitigate, or reduce irregular wearing of tread block 402 or a tread rib (not shown).

In one embodiment, the S-shaped geometry within sipe 410 eliminates the direct path extending radially-inwardly from a ground-contact surface as featured in traditional sipes. The S-shaped geometry may create an indirect path that prevents, or at least reduces the occurrence of, stones or other debris from entering, or lodging, within sipe 410. In this manner, the S-shaped geometry may prevent, or at least reduce the occurrence of, stones or other debris from reducing sipe 410's effectiveness at increasing traction, causing damage to tire tread 400 and/or tread block 402, and/or creating a safety hazard resulting from lodged stones or other debris being ejected during tire operation.

FIG. 5 illustrates a plan view of an example embodiment of a tire tread 500. Tire tread 500 may comprise a tread block 402. Tread block 402 may comprise a ground-contacting surface 404, at least one side surface 406, and a base 408.

FIG. 5 represents a plan view wherein tread block 402 was separated into two halves at the sipe (not shown), which may substantially correspond to a YZ-plane.

Tread block 402, or a tread rib (not shown) may comprise at least one sipe (not shown). At least one sipe (not shown) may comprise at least one convex portion 412 and at least one concave portion 414. In one embodiment, a sipe (not shown) comprises alternating convex portions 412 and concave portions 414 forming an S-shaped geometry in a plane substantially parallel to an XY-plane.

At least one sipe (not shown) may comprise an upper vertical section 416, a first curvilinear portion 418, a second curvilinear portion 420, and a lower vertical section 422. First curvilinear portion 418 and second curvilinear portion 420 may form an S-shaped geometry in a plane substantially parallel to an XZ-plane.

As illustrated in FIG. 5, at least one sipe (not shown) may comprise an S-shaped geometry in each of an XY-plane and an XZ-plane. In another embodiment, at least one sipe (not shown) may comprise an S-shaped geometry in at least one of an XY-plane and an XZ-plane. In another embodiment, at least one sipe (not shown) may comprise an S-shaped geometry in at least two of an XY-plane, an XZ-plane, and a YZ-plane.

FIG. 5 illustrates four independent radial sections of sipe 410. Namely, first section 530, a second section 532, a third section 534, and a fourth section 536. First section 530 may be the radially outermost section, while fourth section 536 may be the radially innermost section. First section 530 may correspond to that section of sipe 410 including an upper vertical section (such as 216). Second section 532 may correspond to that section of sipe 410 including a first curvilinear portion (such as 218). Third section 534 may correspond to that section of sipe 410 including a second curvilinear portion (such as 220). Fourth section 536 may correspond to that section of sipe 410 including a lower vertical section (such as 222).

FIG. 6A illustrates a perspective view of an example embodiment of a tire sipe blade 600. Tire sipe blade 600 may be used in forming a sipe featuring an S-shaped geometry. A tire formed using tire sipe blade 600 may have sipe dimensions substantially similar to those described below with respect to tire sipe blade 600.

As illustrated, tire sipe blade 600 may comprise an S-shaped geometry in planes corresponding to each of an XY-plane and an XZ-plane. In another embodiment, tire sipe blade 600 may comprise an S-shaped geometry in at least one of an XY-plane and an XZ-plane. In another embodiment, tire sipe blade 600 may comprise an S-shaped geometry in at least two of an XY-plane, an XZ-plane, and a YZ-plane.

Tire sipe blade 600 may comprise at least one convex portion 612, at least one concave portion 614, an upper vertical section 616, a first curvilinear portion 618, a second curvilinear portion 620, and a lower vertical section 622.

FIG. 6B illustrates a side elevational view of an example embodiment of a tire sipe blade 600 taken about a view A-A.

Tire sipe blade 600 may include S-shaped geometry having an amplitude A2. Amplitude A2 may be any of a variety of values. In one embodiment, amplitude A2 may range between about 0.25 mm and about 20.0 mm. In another embodiment, amplitude A2 may be greater than about 20.0 mm. In another embodiment, amplitude A2 may be less than about 0.25 mm.

Tire sipe blade 600 may include S-shaped geometry having a wavelength F2. Wavelength F2 may be any of a variety of values. In one embodiment, wavelength F2 may range between about 1.00 mm and about 85.0 mm. In another embodiment, wavelength F2 may be greater than about 85.0 mm. In another embodiment, wavelength F2 may be less than about 1.00 mm.

Tire sipe blade 600 may comprise a thickness T2. Thickness T2 may be any of a variety of values. In one embodiment, thickness T2 may range between about 0.25 mm and about 10.0 mm. In another embodiment, thickness T2 may be greater than about 10.0 mm. In another embodiment, thickness T2 may be less than about 0.25 mm.

Tire sipe blade 600 may comprise a height H. Height H may be any of a variety of values. In one embodiment, height H may range between about 3.00 mm and about 275.0 mm. In another embodiment, height H may be greater than about 275.0 mm. In another embodiment, height H may be less than about 3.00 mm.

FIG. 6B illustrates four independent radial sections of sipe blade 600. Namely, first section 630, a second section 632, a third section 634, and a fourth section 636. First section 630 may be the radially outermost section, while fourth section 636 may be the radially innermost section. First section 630 may correspond to that section of sipe blade 600 including an upper vertical section (such as 616). Second section 632 may correspond to that section of sipe blade 600 including a first curvilinear portion (such as 618). Third section 634 may correspond to that section of sipe blade 600 including a second curvilinear portion (such as 620). Fourth section 636 may correspond to that section of sipe blade 600 including a lower vertical section (such as 622).

FIG. 6C illustrates a top plan view of an example embodiment of a tire sipe blade 600 taken about a view B-B.

Tire sipe blade 600 may include S-shaped geometry having an amplitude A1. Amplitude A1 may be any of a variety of values. In one embodiment, amplitude A1 may range between about 0.25 mm and about 20.0 mm. In another embodiment, amplitude A1 may be greater than about 20.0 mm. In another embodiment, amplitude A1 may be less than about 0.25 mm.

Tire sipe blade 600 may include S-shaped geometry having a wavelength F1. Wavelength F1 may be any of a variety of values. In one embodiment, wavelength F1 may range between about 0.25 mm and about 125.0 mm. In another embodiment, wavelength F1 may be greater than about 125.0 mm. In another embodiment, wavelength F1 may be less than about 0.25 mm.

Tire sipe blade 600 may comprise a thickness T1. Thickness T1 may be any of a variety of values. In one embodiment, thickness T1 may range between about 0.25 mm and about 10.0 mm. In another embodiment, thickness T1 may be greater than about 10.0 mm. In another embodiment, thickness T1 may be less than about 0.25 mm.

Tire sipe blade 600 may comprise a length L. Length L may be any of a variety of values. In one embodiment, length L may range between about 2.00 mm and about 900.0 mm. In another embodiment, length L may be greater than about 900.0 mm. In another embodiment, length L may be less than about 2.00 mm.

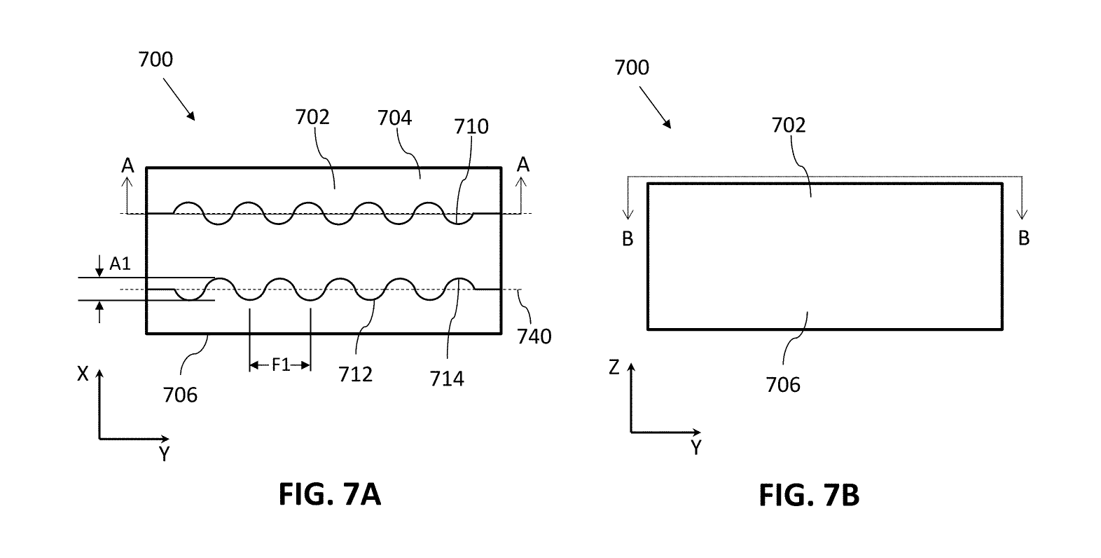

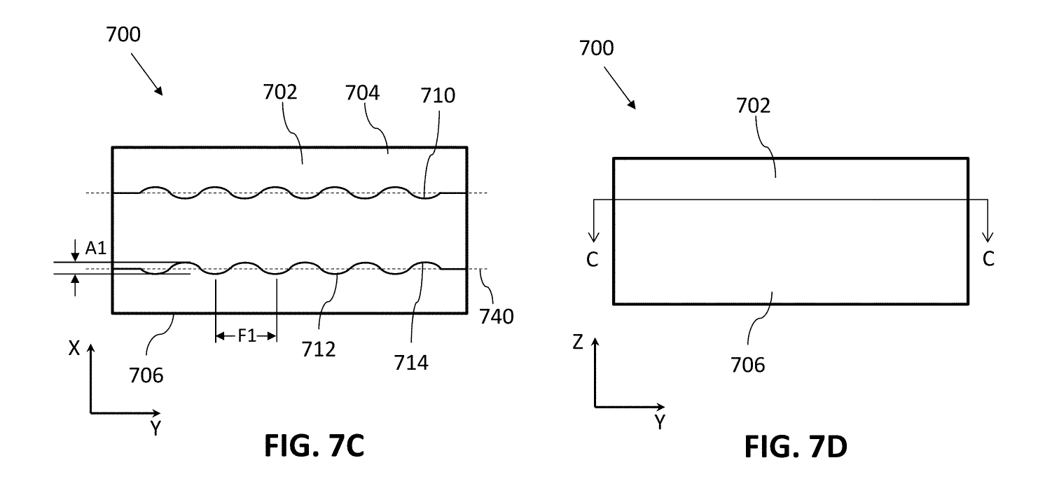

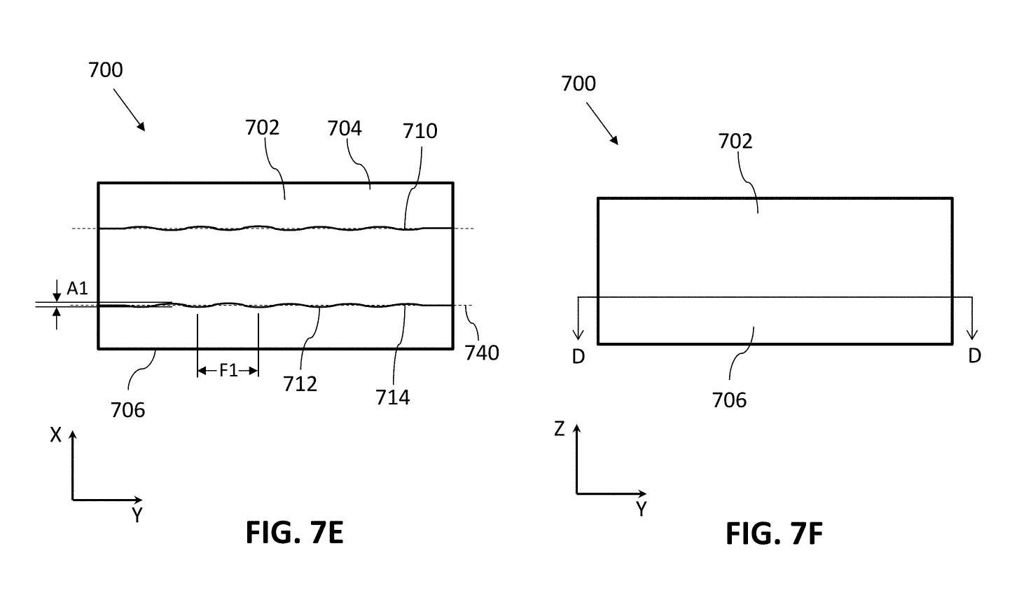

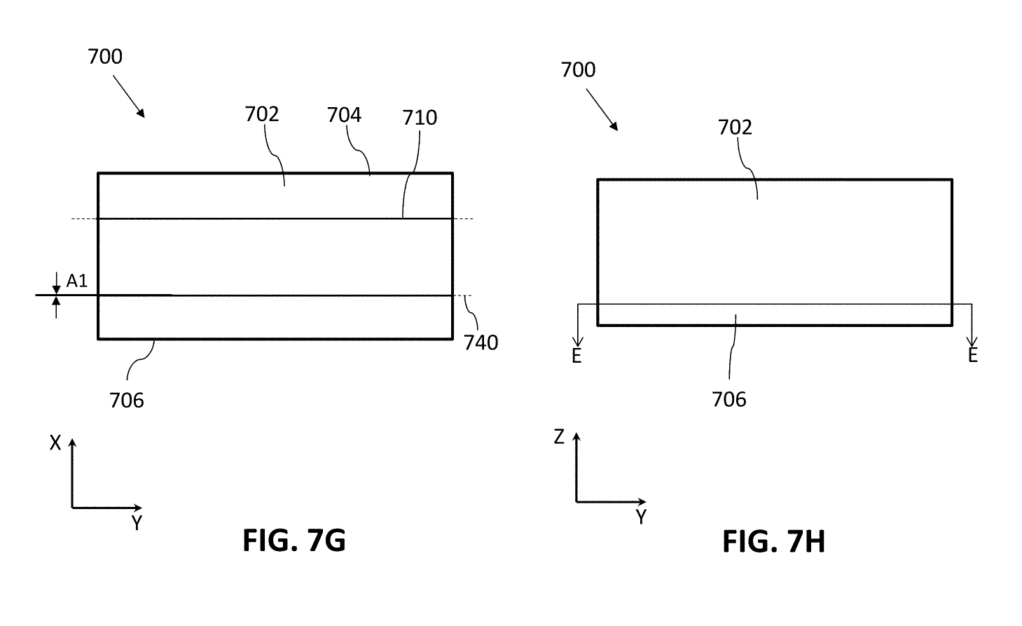

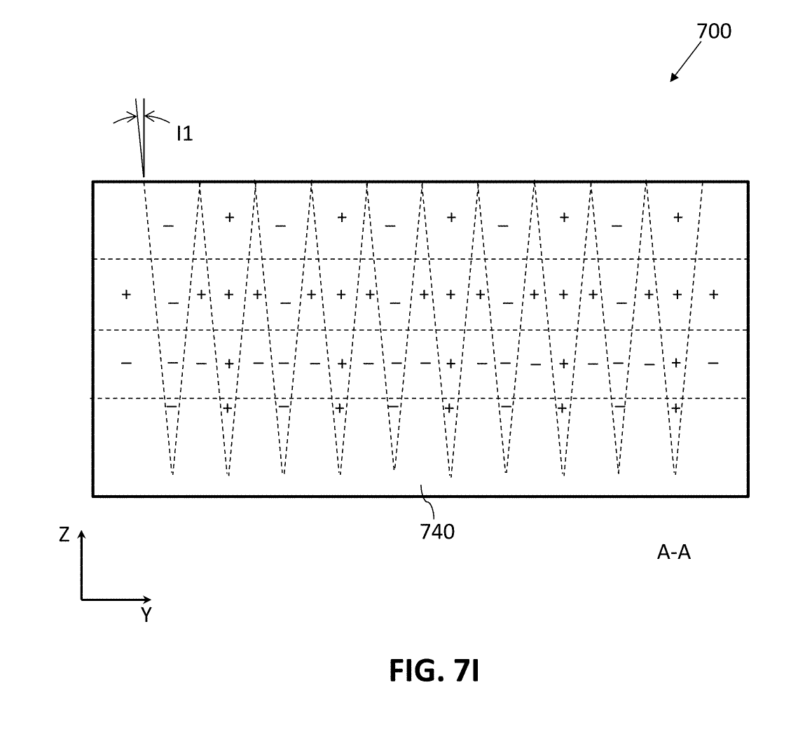

FIGS. 7A-7I illustrate an example embodiment of a tire tread 700 having a sipe featuring a variable S-shaped geometry. FIG. 7A illustrates a top plan view taken from B-B illustrated in FIG. 7B. FIG. 7C illustrates a sectional view taken from C-C illustrated in FIG. 7D. FIG. 7E illustrates a sectional view taken from D-D illustrated in FIG. 7F. FIG. 7G illustrates a sectional view taken from E-E illustrated in FIG. 7H. FIG. 7I illustrates a schematic of a sectional view taken from A-A of FIG. 7A.

FIGS. 7A-7I illustrate a tire tread 700. Tread 700 may comprise a tread block 702. Tread block 702 may comprise a ground-contacting surface 704 and at least one side surface 706. Tread block 702 may comprise at least one sipe 710. At least one sipe 710 may be oriented substantially axially (i.e., substantially parallel to the Y-axis), substantially circumferentially (i.e., substantially parallel to the X-axis), and/or inclined at an angle relative to either the X-axis or the Y-axis. At least one sipe 710 may include a plurality of sipes oriented substantially parallel to one another. At least one sipe 710 may include a plurality of sipes inclined at an angle relative to one another. At least one sipe 710 may include a plurality of sipes oriented parallel to one another, and in phase with one another. At least one sipe 710 may include a plurality of sipes oriented parallel to one another, and out of phase with one another (e.g., as illustrated in FIG. 7A).

At least one sipe 710 may comprise an S-shaped geometry. Sipe 700 may comprise a plurality of alternating convex portions 712 and concave portions 714 (relative to at least one side surface 706). Convex portions 712 and concave portions 714 may be oriented as illustrated in FIG. 7A so as to form a continuous S-shaped geometry along at least a portion of the length of sipe 710.

The S-shaped geometry of sipe 710 may extend all the way to at least one side surface 706. Sipe 710 may intersect at least one side surface 706 with a substantially straight geometry portion, which intersects at least one of convex portion 712 and concave portion 714, such that the S-shaped geometry does not extend to side surface 706. In one embodiment, sipe 710 may not extend to any side surface 706, such that sipe 710 is contained within an interior portion of ground-contacting surface 704.

In one embodiment, sipe 710 may comprise a S-shaped geometry similar to a sinusoidal curve.

The amplitude A1 of the curve in sipe 710 may be constant along the length of sipe 710. The amplitude A1 of the curve in sipe 710 may alternatively vary along the length of sipe 710. The amplitude A1 of the curve in sipe 710 may vary along the radial height (along the Z-axis) of sipe 710. As illustrated in FIGS. 7A-7I, the amplitude A1 of the curve in sipe 710 may decrease as sipe 710 extends radially inwardly in tread block 702. The amplitude A1 of the curve in sipe 710 may increase as sipe 710 extends radially inwardly in tread block 702. The amplitude A1 of the curve in sipe 710 may increase in some sections extending radially within tread block 702, and increase in some sections extending radially within tread block 702.

In one embodiment, the wavelength F1 of the curve in sipe 710 may be constant along the length of sipe 710. The wavelength F1 of the curve in sipe 710 may alternatively vary along the length of sipe 710. In one embodiment, a plurality of sipes 710 may be contained within tread block 702 or tread rib (not shown), and the curves of sipes 710 may be in phase with one another. Alternatively, the curves of sipes 710 may be out of phase with one another as illustrated in FIG. 7A.

A central plane 740 may extend down the center of sipe 710 along its length, and may be parallel to or coplanar with the YZ-plane.

As illustrated in FIGS. 7A, 7C, 7E, and 7G, amplitude A1 of the curve in sipe 710 may decrease as sipe 710 extends radially inwardly within tread block 702. FIGS. 7B, 7D, 7F, and 7H illustrate the radial positions of each sectional view of FIGS. 7A, 7C, 7E, and 7G, with FIG. 7A being a plan view taken above block 702 showing sipe 710 having a maximum amplitude A1, and with FIG. 7G being a sectional view taken at a point where amplitude A1 reaches a minimum value and sipe 710 becomes a substantially straight line.

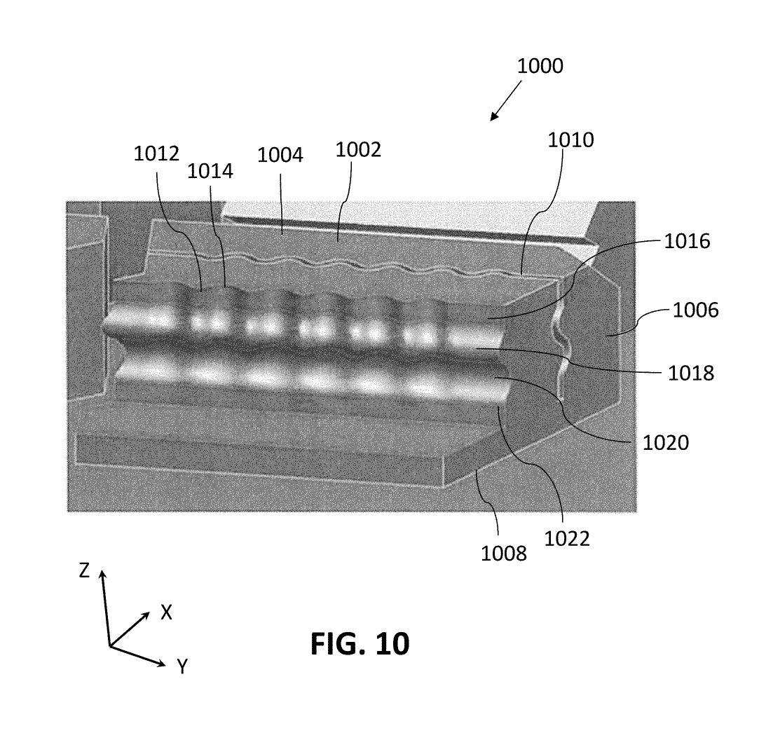

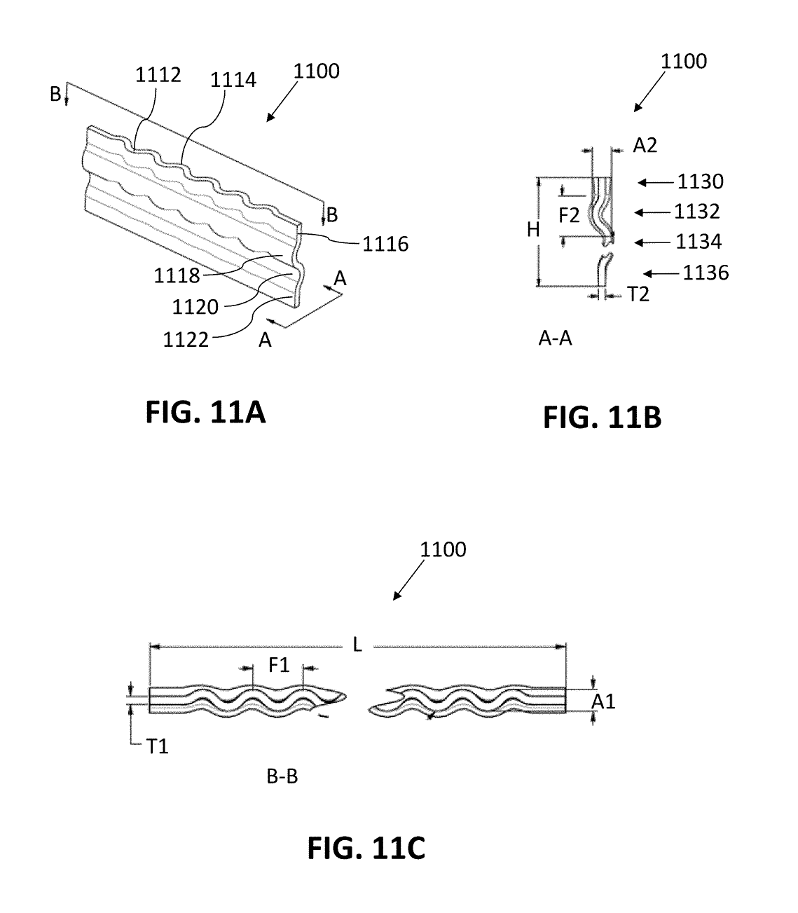

FIG. 7I illustrates a schematic of a sectional view of an example embodiment of a tire tread 700 featuring an S-shaped geometry taken from A-A in FIG. 7A. Independent blocks (represented by rectangles) generally represent sections of sipe 710 (illustrated as sipe 1010 in FIG. 10) divided by sipe 710 crossing central plane 740 extending along the length of sipe 710 and parallel to or coplanar with the YZ-plane. Blocks containing a “+” symbol indicate a portion of sipe 710 that is convex, or extending out of the page. Blocks containing a “−” symbol indicate a portion of sipe 710 that is concave, or extending into the page. Blocks containing no symbol indicate a portion of sipe 710 falling on or near a central plane extending along the length of sipe 710 and parallel to or coplanar with the YZ-plane. FIG. 7I may be a schematic representation of sipe formed by sipe blade 1100 illustrated in FIG. 11A, which may appear similar to sipe 1010 illustrated in FIG. 10.

As illustrated in FIG. 7I, sipe 710 may include curves that narrow due to the decreasing amplitude A1 and constant wavelength F1 as sipe 710 extends radially inwardly into block 702.

The dashed lines generally representing the width of the curves that narrow due to the decreasing amplitude A1 and constant wavelength F1 as sipe 710 extends radially inwardly into block 702 are inclined relative to the Z-axis by an inclination angle I1. Angle I1 may be between about 5 degrees and about 10 degrees. Angle I1 may be about 5 degrees. Angle I1 may be about 10 degrees. Angle I1 may be less than about 5 degrees and greater than about 10 degrees.

Stated differently, the amplitude A1 of sipe 710 may decrease in value at a ratio of between about 1:12 and about 1:6 of the distance that sipe 710 extends radially inwardly into block 702 until amplitude A1 has a value of zero. Alternatively, the amplitude A1 of sipe 710 may increase in value at a ratio of between about 1:12 and about 1:6 as sipe 710 extends radially inwardly into block 702.

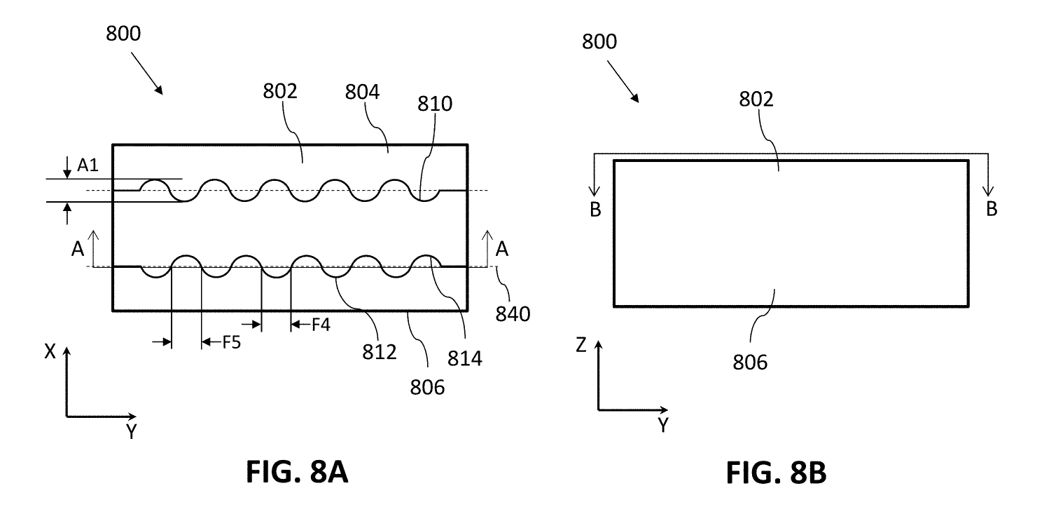

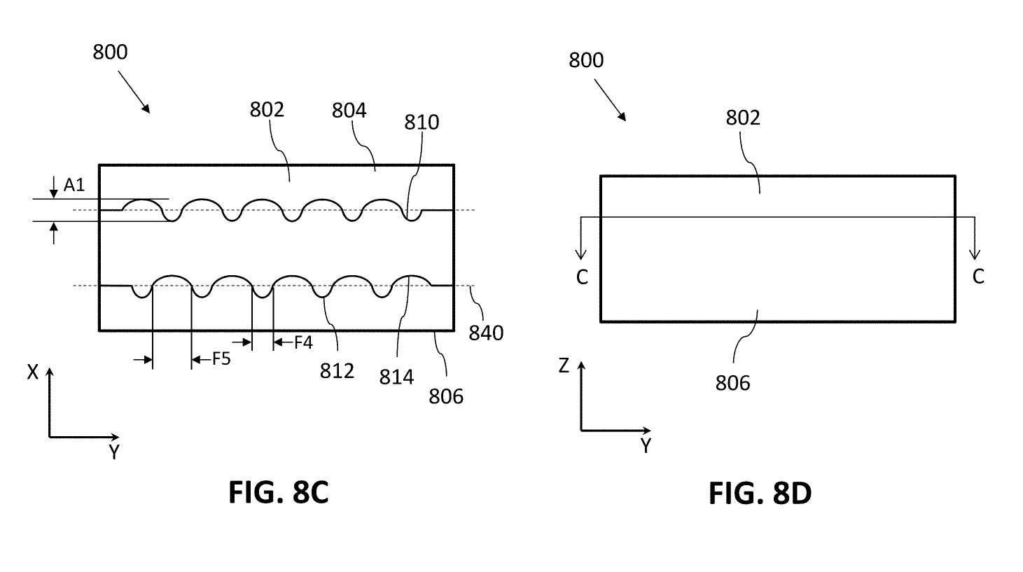

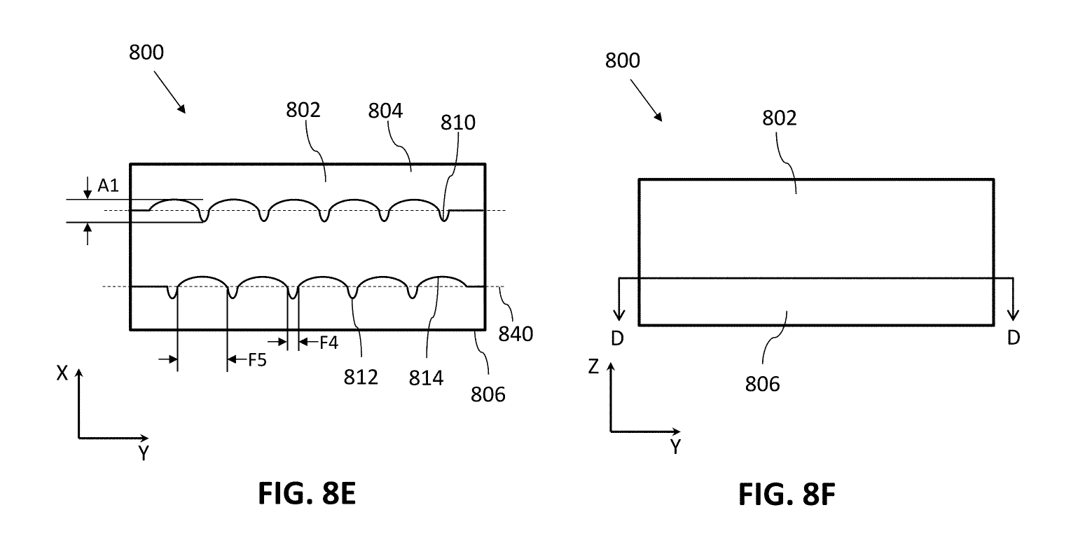

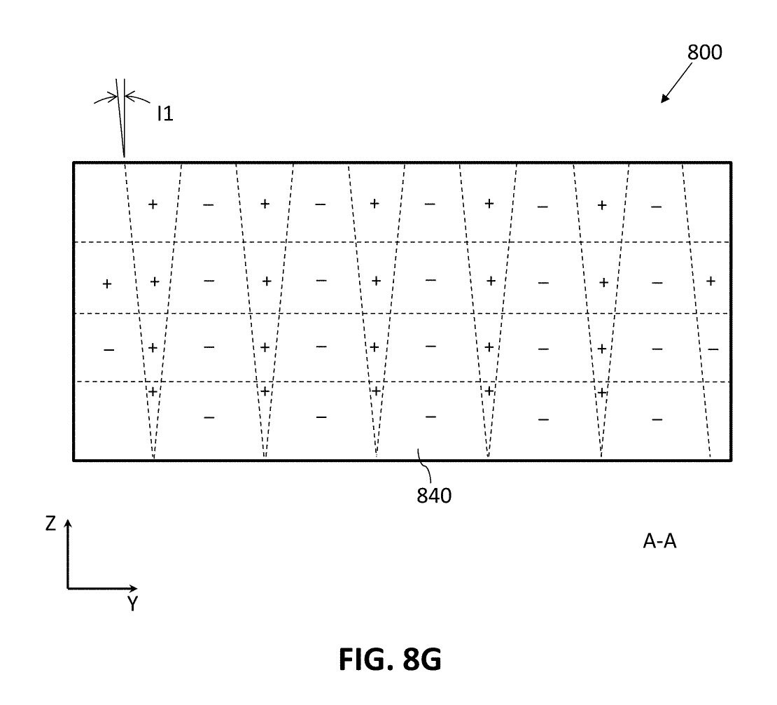

FIGS. 8A-8G illustrate an example embodiment of a tire tread 800 having a sipe featuring a variable S-shaped geometry. FIG. 8A illustrates a top plan view taken from B-B illustrated in FIG. 8B. FIG. 8C illustrates a sectional view taken from C-C illustrated in FIG. 8D. FIG. 8E illustrates a sectional view taken from D-D illustrated in FIG. 8F. FIG. 8G illustrates a schematic of a sectional view taken from A-A of FIG. 8A.

FIGS. 8A-8G illustrate a tire tread 800. Tread 800 may comprise a tread block 802. Tread block 802 may comprise a ground-contacting surface 804 and at least one side surface 806. Tread block 802 may comprise at least one sipe 810. At least one sipe 810 may be oriented substantially axially (i.e., substantially parallel to the Y-axis), substantially circumferentially (i.e., substantially parallel to the X-axis), and/or inclined at an angle relative to either the X-axis or the Y-axis. At least one sipe 810 may include a plurality of sipes oriented substantially parallel to one another. At least one sipe 810 may include a plurality of sipes inclined at an angle relative to one another. At least one sipe 810 may include a plurality of sipes oriented parallel to one another, and in phase with one another. At least one sipe 810 may include a plurality of sipes oriented parallel to one another, and out of phase with one another (e.g., as illustrated in FIG. 8A).

At least one sipe 810 may comprise an S-shaped geometry. Sipe 800 may comprise a plurality of alternating convex portions 812 and concave portions 814 (relative to at least one side surface 806). Convex portions 812 and concave portions 814 may be oriented as illustrated in FIG. 8A so as to form a continuous S-shaped geometry along at least a portion of the length of sipe 810.

The S-shaped geometry of sipe 810 may extend all the way to at least one side surface 806. Sipe 810 may intersect at least one side surface 806 with a substantially straight geometry portion, which intersects at least one of convex portion 812 and concave portion 814, such that the S-shaped geometry does not extend to side surface 806. In one embodiment, sipe 810 may not extend to any side surface 806, such that sipe 810 is contained within an interior portion of ground-contacting surface 804.

In one embodiment, sipe 810 may comprise a S-shaped geometry similar to a sinusoidal curve.

The amplitude A1 of the curve in sipe 810 may be constant along the length of sipe 810. The amplitude A1 of the curve in sipe 810 may alternatively vary along the length of sipe 810. The amplitude A1 of the curve in sipe 810 may vary along the radial height (along the Z-axis) of sipe 810. As illustrated in FIGS. 8A-8G, the amplitude A1 of the curve in sipe 810 may decrease as sipe 810 extends radially inwardly in tread block 802. The amplitude A1 of the curve in sipe 810 may increase as sipe 810 extends radially inwardly in tread block 802. The amplitude A1 of the curve in sipe 810 may increase in some sections extending radially within tread block 802, and increase in some sections extending radially within tread block 802.

Sipe 810 may have two half-wavelengths F4 and F5. Half-wavelengths F4 and F5 may be constant along the length of sipe 810. Alternatively, half-wavelengths F4 and F5 may vary along the length of sipe 810. In one embodiment, a plurality of sipes 810 may be contained within tread block 802 or tread rib (not shown), and the curves of sipes 810 may be in phase with one another. Alternatively, the curves of sipes 810 may be out of phase with one another as illustrated in FIG. 8A.

Half-wavelength F5 of concave portion 814 may increase as sipe 810 extends radially inwardly into block 802, while half-wavelength F4 of convex portion 812, may decrease as sipe 810 extends radially inwardly into block 802. The amplitude A1 of both convex portions 812 and concave portions 814 of sipe 810 may remain constant as sipe 810 extends radially inwardly into block 802. Alternatively, the amplitude A1 of one or both of these portions may vary.

A central plane 840 may extend down the center of sipe 810 along its length, and may be parallel to or coplanar with the YZ-plane. Half-wavelength F4 may be defined as the length of sipe 810 in convex portion 812. The point at which sipe 810 (or sipe 710, for that matter) crosses central plane 840 may be the dividing point between convex portion 812 and concave portion 814. As such, half-wavelength F4 may be measured from two adjacent points where sipe 810 crosses central plane 840 on the side of central plane 840 that is referenced as being the “convex” side. It is understood that the terms “concave” and “convex” used herein are simply relative to one another in order to differentiate those portions of sipe 810 on a first side of central plane (e.g., 840) and those portions of sipe 810 on a second side of central plane (e.g., 840). Half-wavelength F5 may be defined as the length of sipe 810 in concave portion 814. Half-wavelength F5 may be measured from two adjacent points where sipe 810 crosses central plane 840 on the side of central plane 840 that is referenced as being the “concave” side.

As illustrated in FIGS. 8A, 8C, and 8E, half-wavelengths F4 and F5 of the curves in sipe 810 may vary as sipe 810 extends radially inwardly within tread block 802. FIGS. 8B, 8D, and 8F, illustrate the radial positions of each sectional view of FIGS. 8A, 8C, and 8E, with FIG. 8A being a plan view taken above block 802 showing sipe 810 where half-wavelengths F4 and F5 are approximately equal, and with FIG. 8E being a sectional view taken at a point where half-wavelength F5 of concave portions 814 is at a maximum, while half-wavelength F4 of convex portions 812 is at a minimum. FIGS. 8A, 8C, and 8E illustrate a progression of sipe 810 where half-wavelength F4 of convex portion 812 decreases in magnitude and where half-wavelength F5 of concave portion 814 increases in magnitude.

The magnitude of the sum of half-wavelengths F4 and F5 may remain constant as sipe 810 extends radially inwardly within tread block 802. Thus, half-wavelength F5 increases by the same amount as half-wavelength F4 decreases.

FIG. 8G illustrates a schematic of a sectional view of an example embodiment of a tire tread 800 featuring an S-shaped geometry taken from A-A in FIG. 8A. Independent blocks (represented by rectangles) generally represent sections of sipe 810 divided by sipe 810 crossing central plane 840 extending along the length of sipe 810 and parallel to or coplanar with the YZ-plane. Blocks containing a “+” symbol indicate a portion of sipe 810 that is convex, or extending out of the page. Blocks containing a “−” symbol indicate a portion of sipe 810 that is concave, or extending into the page. Blocks containing no symbol indicate a portion of sipe 810 falling on or near a central plane extending along the length of sipe 810 and parallel to or coplanar with the YZ-plane. FIG. 8G may be a schematic representation of sipe formed by sipe blade 1100 illustrated in FIG. 11A, which may appear similar to sipe 1010 illustrated in FIG. 10.

As illustrated in FIG. 8G, sipe 810 may include curves that alternatingly narrow and widen due to the constant amplitude A1 and varying half-wavelengths F4 and F5 as sipe 810 extends radially inwardly into block 802.

The dashed lines generally representing the width of the curves that narrow due to the constant amplitude A1 and narrowing half-wavelength F4 as sipe 810 extends radially inwardly into block 802 are inclined relative to the Z-axis by an inclination angle I1. Angle I1 may be between about 5 degrees and about 10 degrees. Angle I1 may be about 5 degrees. Angle I1 may be about 10 degrees. Angle I1 may be less than about 5 degrees and greater than about 10 degrees. The total of adjacent inclination angles I1 may add to between about 10 degrees and about 20 degrees.

Stated differently, the amplitude A1 of sipe 810 may decrease in value at a ratio of between about 1:12 and about 1:6 of the distance that sipe 810 extends radially inwardly into block 802 until amplitude A1 has a value of zero. Alternatively, the amplitude A1 of sipe 810 may increase in value at a ratio of between about 1:12 and about 1:6 as sipe 810 extends radially inwardly into block 802.

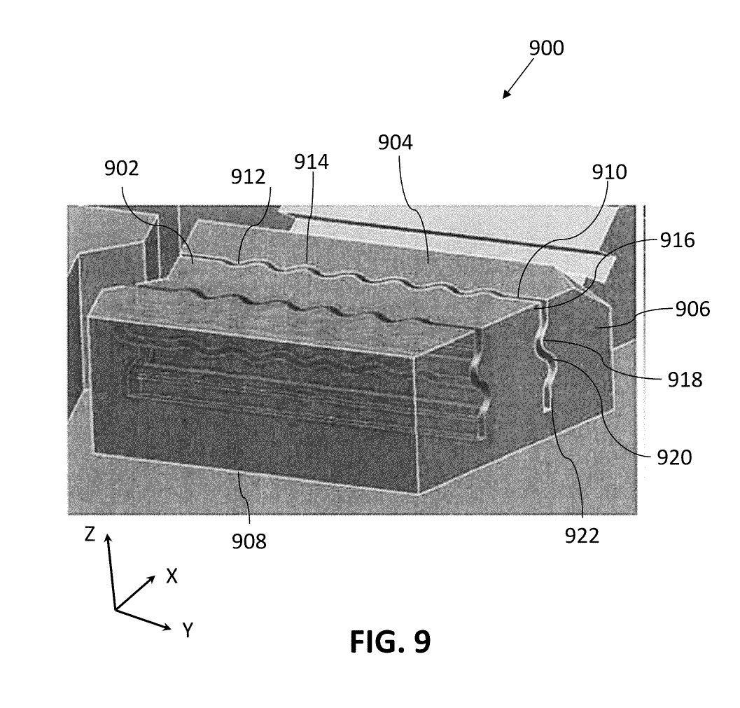

FIG. 9 illustrates a perspective view of an example embodiment of a tire tread 900. Tire tread 900 may comprise a tread block 902. Tread block 902 may comprise a ground-contacting surface 904, at least one side surface 906, and a base 908.

Tread block 902, or a tread rib (not shown), may comprise at least one sipe 910. At least one sipe 910 may comprise at least one convex portion 912 and at least one concave portion 914. In one embodiment, sipe 910 comprises alternating convex portions 912 and concave portions 914 forming an S-shaped geometry in a plane substantially parallel to an XY-plane.

At least one sipe 910 may comprise an upper vertical section 916, a first curvilinear portion 918, a second curvilinear portion 920, and a lower vertical section 922. First curvilinear portion 918 and second curvilinear portion 920 may form an S-shaped geometry in a plane substantially parallel to an XZ-plane.

As illustrated in FIG. 9, at least one sipe 910 may comprise an S-shaped geometry in each of an XY-plane and an XZ-plane. In another embodiment, at least one sipe 910 may comprise an S-shaped geometry in at least one of an XY-plane and an XZ-plane. In another embodiment, at least one sipe 910 may comprise an S-shaped geometry in at least two of an XY-plane, an XZ-plane, and a YZ-plane. At least one sipe 910 may comprise a curve having an amplitude that varies along the radial height of sipe 910 in a YZ-plane. At least one sipe 910 may comprise a curve having a wavelength that varies along the radial height of sipe 910 in a YZ-plane.

In one embodiment, the S-shaped geometry within sipe 910 creates a series of protrusions and indentations configured to engage one another and increase stiffness of tread block 902 or a tread rib (not shown). Increased stiffness of tread block 902 or a tread rib (not shown) may prevent, mitigate, or reduce irregular wearing of tread block 902 or a tread rib (not shown).

In one embodiment, the S-shaped geometry within sipe 910 eliminates the direct path extending radially-inwardly from a ground-contact surface as featured in traditional sipes. The S-shaped geometry may create an indirect path that prevents stones or other debris from entering, or lodging, within sipe 910. In this manner, the S-shaped geometry may prevent stones or other debris from reducing sipe 910's effectiveness at increasing traction, causing damage to tire tread 900 and/or tread block 902, and/or creating a safety hazard resulting from lodged stones or other debris being ejected during tire operation.

FIG. 10 illustrates a plan view of an example embodiment of a tire tread 1000. Tire tread 1000 may comprise a tread block 1002. Tread block 1002 may comprise a ground-contacting surface 1004, at least one side surface 1006, and a base 1008.

FIG. 10 represents a plan view wherein tread block 902 was separated into two halves at the sipe (not shown), which may substantially correspond to a YZ-plane.

Tread block 1002, or a tread rib (not shown), may comprise at least one sipe (not shown). At least one sipe (not shown) may comprise at least one convex portion 1012 and at least one concave portion 1014. In one embodiment, a sipe (not shown) comprises alternating convex portions 1012 and concave portions 1014 forming an S-shaped geometry in a plane substantially parallel to an XY-plane.

At least one sipe (not shown) may comprise an upper vertical section 1016, a first curvilinear portion 1018, a second curvilinear portion 1020, and a lower vertical section 1022. First curvilinear portion 1018 and second curvilinear portion 1020 may form an S-shaped geometry in a plane substantially parallel to an XZ-plane.

As illustrated in FIG. 10, at least one sipe (not shown) may comprise an S-shaped geometry in each of an XY-plane and an XZ-plane. In another embodiment, at least one sipe (not shown) may comprise an S-shaped geometry in at least one of an XY-plane and an XZ-plane. In another embodiment, at least one sipe (not shown) may comprise an S-shaped geometry in at least two of an XY-plane, an XZ-plane, and a YZ-plane. In one embodiment, at least one sipe (not shown) may comprise a curve having an amplitude that varies along the height of the sipe (not shown) in a YZ-plane, a wavelength that varies along the height of the sipe in a YZ-plane, or both an amplitude and a wavelength that vary along the height of the sipe in a YZ-plane.

FIG. 11A illustrates a perspective view of an example embodiment of a tire sipe blade 1100. Tire sipe blade 1100 may be used in forming a sipe featuring an S-shaped geometry. A tire formed using tire sipe blade 1100 may have sipe dimensions substantially similar to those described below with respect to tire sipe blade 1100.

As illustrated, tire sipe blade 1100 may comprise an S-shaped geometry in planes corresponding to each of an XY-plane, an XZ-plane, and a YZ-plane. In another embodiment, tire sipe blade 1100 may comprise an S-shaped geometry in at least one of an XY-plane, an XZ-plane, and a YZ-plane. In another embodiment, tire sipe blade 1100 may comprise an S-shaped geometry in at least two of an XY-plane, an XZ-plane, and a YZ-plane. In one embodiment, tire sipe blade 1100 may comprise a curve having an amplitude that varies along the height of sipe blade 1100 in a YZ-plane. In one embodiment, tire sipe blade 1100 may comprise a curve having an amplitude that decreases along the height of sipe blade 1100 in a YZ-plane.

Tire sipe blade 1100 may comprise at least one convex portion 1112, at least one concave portion 1114, an upper vertical section 1116, a first curvilinear portion 1118, a second curvilinear portion 1120, and a lower vertical section 1122.

FIG. 11B illustrates a side elevational view of an example embodiment of a tire sipe blade 1100 taken about a view A-A.

Tire sipe blade 1100 may include S-shaped geometry having an amplitude A2. Amplitude A2 may be any of a variety of values. In one embodiment, amplitude A2 may range between about 0.25 mm and about 20.0 mm. In another embodiment, amplitude A2 may be greater than about 20.0 mm. In another embodiment, amplitude A2 may be less than about 0.25 mm. Amplitude A2 may vary as sipe blade 1100 extends from an upper vertical section 1116 to a lower vertical section 1122. Amplitude A2 may decrease as sipe blade 1100 extends from an upper vertical section 1116 to a lower vertical section 1122.

Tire sipe blade 1100 may include S-shaped geometry having a wavelength F2. Wavelength F2 may be any of a variety of values. In one embodiment, wavelength F2 may range between about 1.00 mm and about 85.0 mm. In another embodiment, wavelength F2 may be greater than about 85.0 mm. In another embodiment, wavelength F2 may be less than about 1.00 mm.

Tire sipe blade 1100 may comprise a thickness T2. Thickness T2 may be any of a variety of values. In one embodiment, thickness T2 may range between about 0.25 mm and about 10.0 mm. In another embodiment, thickness T2 may be greater than about 10.0 mm. In another embodiment, thickness T2 may be less than about 0.25 mm. Thickness T2 may be constant through sipe blade 1100. Alternatively, thickness T2 may vary as sipe blade 1100 extends from upper vertical section 1116 to lower vertical section 1122, including an increase in thickness, decrease in thickness, or both in alternate portions.

Tire sipe blade 1100 may comprise a height H. Height H may be any of a variety of values. In one embodiment, height H may range between about 3.00 mm and about 275.0 mm. In another embodiment, height H may be greater than about 275.0 mm. In another embodiment, height H may be less than about 3.00 mm.

FIG. 11B illustrates four independent radial sections of sipe blade 1100. Namely, first section 1130, a second section 1132, a third section 1134, and a fourth section 1136. First section 1130 may be the radially outermost section, while fourth section 1136 may be the radially innermost section. First section 1130 may correspond to that section of sipe blade 1100 including an upper vertical section (such as 1116). Second section 1132 may correspond to that section of sipe blade 1100 including a first curvilinear portion (such as 1118). Third section 1134 may correspond to that section of sipe blade 1100 including a second curvilinear portion (such as 1120). Fourth section 1136 may correspond to that section of sipe blade 1100 including a lower vertical section (such as 1122).

FIG. 11C illustrates a top plan view of an example embodiment of a tire sipe blade 1100 taken about a view B-B.

Tire sipe blade 1100 may include S-shaped geometry having an amplitude A1. Amplitude A1 may be any of a variety of values. In one embodiment, amplitude A1 may range between about 0.25 mm and about 20.0 mm. In another embodiment, amplitude A1 may be greater than about 20.0 mm. In another embodiment, amplitude A1 may be less than about 0.25 mm. Amplitude A1 may vary as sipe blade 1100 extends from an upper vertical section 1116 to a lower vertical section 1122. Amplitude A1 may decrease as sipe blade 1100 extends from an upper vertical section 1116 to a lower vertical section 1122.

Tire sipe blade 1100 may include S-shaped geometry having a wavelength F1. Wavelength F1 may be any of a variety of values. In one embodiment, wavelength F1 may range between about 1.00 mm and about 85.0 mm. In another embodiment, wavelength F1 may be greater than about 85.0 mm. In another embodiment, wavelength F1 may be less than about 1.00 mm. Wavelength F1 may vary as sipe blade 1100 extends from an upper vertical section 1116 to a lower vertical section 1122. Wavelength F1 may increase or decrease as sipe blade 1100 extends from an upper vertical section 1116 to a lower vertical section 1122. In one embodiment, the wavelength F1 of convex portion 1112 may decrease as sipe blade 1110 extends from upper vertical section 1116 to lower vertical section 1122 and the wavelength F1 of concave portion 1114 may increase as sipe blade 1110 extends from upper vertical section 1116 to lower vertical section 1122, or vice versa.

Tire sipe blade 1100 may comprise a thickness T1. Thickness T1 may be any of a variety of values. In one embodiment, thickness T1 may range between about 0.25 mm and about 10.0 mm. In another embodiment, thickness T1 may be greater than about 10.0 mm. In another embodiment, thickness T1 may be less than about 0.25 mm. Thickness T1 may be constant through sipe blade 1100. Alternatively, thickness T1 may vary as sipe blade 1100 extends from upper vertical section 1116 to lower vertical section 1122, including an increase in thickness, decrease in thickness, or both in alternate portions.

Tire sipe blade 1100 may comprise a length L. Length L may be any of a variety of values. In one embodiment, length L may range between about 2.00 mm and about 900.0 mm. In another embodiment, length L may be greater than about 900.0 mm. In another embodiment, length L may be less than about 2.00 mm.

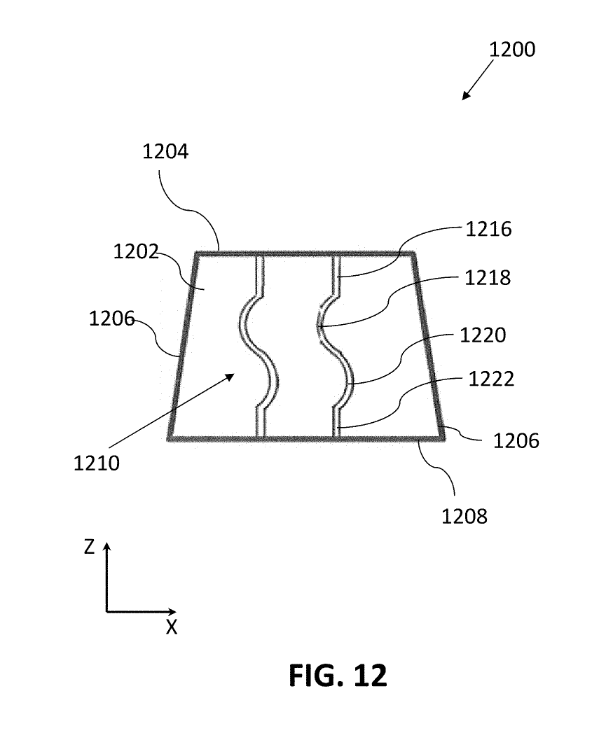

FIG. 12 illustrates a side elevational view of an example embodiment of a tire tread 1200. Tread 1200 may comprise a tread block 1202. Tread block 1202 may comprise a ground-contacting surface 1204, at least one side surface 1206, and a base 1208.

In one embodiment, tread 1200 comprises at least one of tread block 1202, and a tread rib (not shown).

Tread block 1202 may comprise at least one sipe 1210. At least one sipe 1210 may open to at least one side surface 1206. In one embodiment, at least one sipe 1210 may not open to any side surface 1206.

At least one sipe 1210 may comprise an upper vertical section 1216 in communication with ground-contacting surface 1204. Upper vertical section 1216 may comprise a sipe section substantially parallel to the Z-axis. In one embodiment, upper vertical section 1216 may be inclined relative to the Z-axis. In one embodiment, upper vertical section 1216 is substantially coplanar with a YZ-plane. In one embodiment, upper vertical section 1216 is inclined at an angle relative to a YZ-plane.

At least one sipe 1210 may comprise a first curvilinear portion 1218. At least one sipe 1210 may comprise a second curvilinear portion 1220. First curvilinear portion 1218 and second curvilinear portion 1220 may be oriented so as to form an S-shaped geometry. In one embodiment, at least one sipe 1210 comprises additional curvilinear portions (not shown) oriented relative to first curvilinear portion 1218 and second curvilinear portion 1220 so as to form an extended S-shaped geometry.

In one embodiment, first curvilinear portion 1218 may communicate with ground-contacting surface directly. In one embodiment, second curvilinear portion 1220 may communicate with base 1208 directly. Additional curvilinear portions (not shown) may communicate with ground contacting portion 1204, base 1208, upper vertical section 1216, and/or a lower vertical section 1222.

At least one sipe 1210 may comprise lower vertical section 1222. Lower vertical section 1222 may contact base 1208. Lower vertical section 1222 may comprise a sipe section substantially parallel to the Z-axis. In one embodiment, lower vertical section 1222 may be inclined relative to the Z-axis. In one embodiment, lower vertical section 1222 is substantially coplanar with a YZ-plane. In one embodiment, lower vertical section 1222 is inclined at an angle relative to a YZ-plane. In one embodiment, upper vertical section 1216 and lower vertical section 1222 are substantially parallel. In another embodiment, upper vertical section 1216 and lower vertical section 1222 are substantially coplanar.

In one embodiment, first curvilinear portion 1218 and second curvilinear portion 1220 of sipe 1210 may comprise a S-shaped geometry similar to a sinusoidal curve. The amplitude of the curve in sipe 1210 may be constant along the height of sipe 1210. The amplitude of the curve in sipe 1210 may alternatively vary along the height of sipe 1210. In one embodiment, the wavelength of the curve in sipe 1210 may be constant along the height of sipe 1210. The wavelength of the curve in sipe 1210 may alternatively vary along the height of sipe 1210. In one embodiment, a plurality of sipes 1210 may be contained within tread block 1202 or tread rib (not shown), and the curves of sipes 1210 may be in phase with one another. Alternatively, the curves of sipes 1210 may be out of phase with one another.

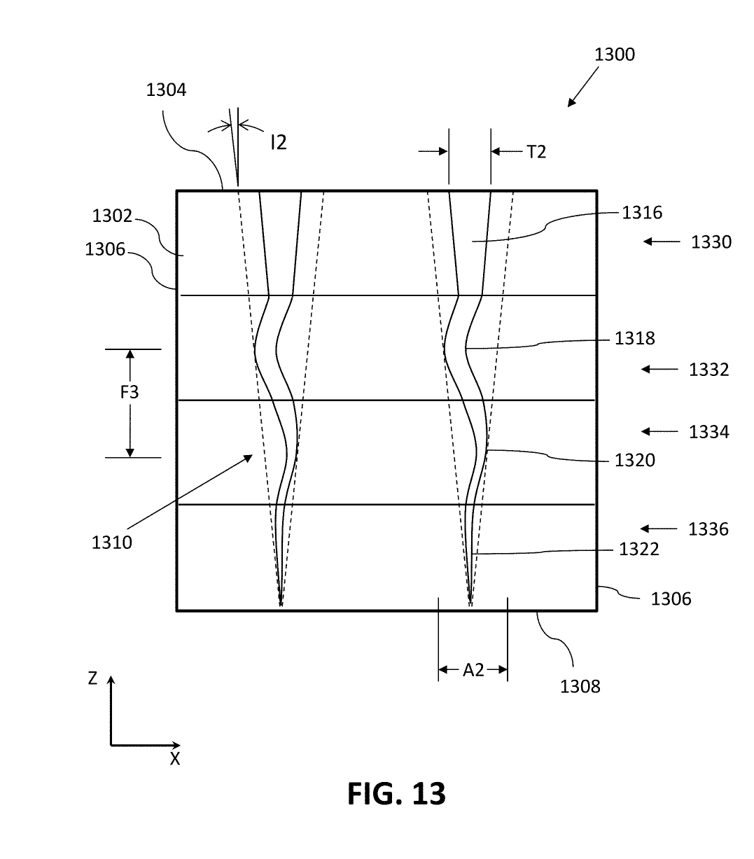

FIG. 13 illustrates a side elevational view of an example embodiment of a tire tread 1300. Tread 1300 may comprise a tread block 1302, a ground-contacting surface 1304, at least one side surface 1306, and a base 1308.

Tread block 1302 may comprise at least one sipe 1310. At least one sipe 1310 may open to at least one side surface 1306. In one embodiment, at least one sipe 1310 may not open to any side surface 1306.

At least one sipe 1310 may comprise an upper vertical section 1316 in communication with ground-contacting surface 1304. Upper vertical section 1316 may comprise a sipe section substantially parallel to the Z-axis.

At least one sipe 1310 may comprise a first curvilinear portion 1318. At least one sipe 1310 may comprise a second curvilinear portion 1320. First curvilinear portion 1318 and second curvilinear portion 1320 may be oriented so as to form an S-shaped geometry.

In one embodiment, first curvilinear portion 1318 may communicate with ground-contacting surface directly. In one embodiment, second curvilinear portion 1320 may communicate with base 1308 directly.

At least one sipe 1310 may comprise lower vertical section 1322. Lower vertical section 1322 may contact base 1308. Lower vertical section 1322 may comprise a sipe section substantially parallel to the Z-axis.

FIG. 13 illustrates four independent radial sections of tread 1300. Namely, first section 1330, a second section 1332, a third section 1334, and a fourth section 1336. First section 1330 may be the radially outermost section, while fourth section 1336 may be the radially innermost section. First section 1330 may correspond to that section of tread 1300 including an upper vertical section (such as 1316). Second section 1332 may correspond to that section of tread 1300 including a first curvilinear portion (such as 1318). Third section 1334 may correspond to that section of tread 1300 including a second curvilinear portion (such as 1320). Fourth section 1336 may correspond to that section of tread 1300 including a lower vertical section (such as 1322).

In one embodiment, first curvilinear portion 1318 and second curvilinear portion 1320 of sipe 1310 may comprise a S-shaped geometry similar to a sinusoidal curve. The amplitude A2 of the curve in sipe 1310 may vary along the radial height of sipe 1310. The wavelength F3 of the curve in sipe 1310 may be constant along the height of sipe 1310. The wavelength F3 of the curve in sipe 1310 may alternatively vary along the height of sipe 1310. In one embodiment, a plurality of sipes 1310 may be contained within tread block 1302 or tread rib (not shown), and the curves of sipes 1310 may be in phase with one another. Alternatively, the curves of sipes 1310 may be out of phase with one another.

The amplitude A2 of the curve in sipe 1310 may decrease along the height of sipe 1310 as sipe 1310 extends radially inwardly into block 1302. The dashed lines representing the amplitude A2 of the curves of sipe 1310 at various positions along its radial height are inclined relative to the Z-axis by an inclination angle 12. Angle 12 may be between about 5 degrees and about 10 degrees. Angle 12 may be about 5 degrees. Angle 12 may be about 10 degrees. Angle 12 may be less than about 5 degrees and greater than about 10 degrees.

Stated differently, the amplitude A2 of sipe 1310 may decrease in value at a ratio of between about 1:12 and about 1:6 of the distance that sipe 1310 extends radially inwardly into block 1302 until amplitude A2 has a value of zero. Alternatively, the amplitude A2 of sipe 1310 may increase in value at a ratio of between about 1:12 and about 1:6 as sipe 1310 extends radially inwardly into block 1302.

Sipe 1310 may have a thickness T2. Thickness T2 may be defined as the distance between sipe sidewalls bounding sipe 1310, measured perpendicular to tangent lines taken at a radial height (measured along the Z-axis). Stated differently, thickness T2 is the thickness of sipe 1310 across sipe 1310, regardless of the angle of sipe 1310 at the point of measurement.

Sipe 1310 may have a variable thickness T2 decreasing along its entire radial height (from ground-contacting surface 1304 to or toward base 1308). Alternatively, sipe 1310 may have a variable thickness T2 increasing along its entire radial height (from ground-contacting surface 1304 to or toward base 1308). Alternatively, sipe 1310 may have a variable thickness T2 along one or more portion of sipe 1310's radial height and a constant thickness T2 along one or more portion of sipe 1310's radial height. For example, sipe 1310 may have a variable thickness T2 in upper vertical section 1316 and a constant thickness T2 in the remainder of sipe 1310's radial height. In another example, sipe 1310 may have a constant thickness T2 in upper vertical section 1316 and a variable thickness T2 in the remainder of sipe 1310's radial height. It is understood that any section (radially) of sipe 1310 may have a constant thickness T2 or variable thickness T2. Sipe 1310 may have a thickness T2 that is constant, or variable, in the XZ-plane.

Sipe 1310 may have a variable thickness T2 decreasing or increasing at a constant rate, variable rate, or a combination thereof. For example, sipe 1310 may have a thickness T2 of about 2.0 mm at ground-contacting surface 1304), a thickness T2 of about 1.0 mm at one half of sipe 1310's radial height, and may decrease to a thickness T2 of about 0.0 mm at sipe 1310's radially innermost portion (illustrated in FIG. 13 at about base 1308, but being understood that sipe 1310 may have a radially innermost portion 1308 at a point radially inward or radially outward of base 1308).

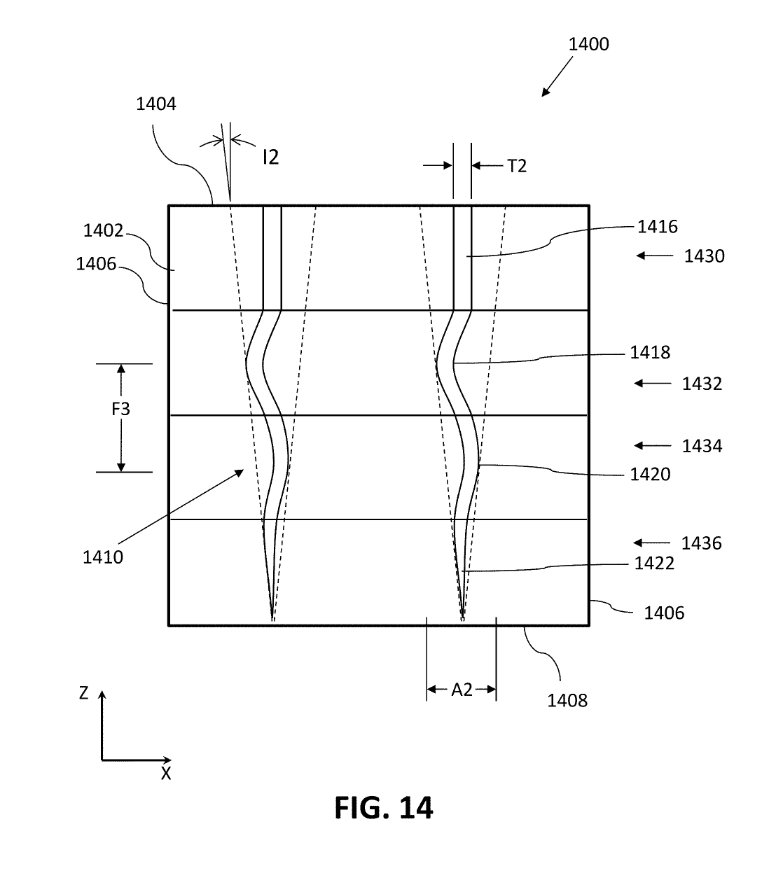

FIG. 14 illustrates a side elevational view of an example embodiment of a tire tread 1400. Tread 1400 may comprise a tread block 1402, a ground-contacting surface 1404, at least one side surface 1406, and a base 1408.

Tread block 1402 may comprise at least one sipe 1410. At least one sipe 1410 may open to at least one side surface 1406. In one embodiment, at least one sipe 1410 may not open to any side surface 1406.

At least one sipe 1410 may comprise an upper vertical section 1416 in communication with ground-contacting surface 1404. Upper vertical section 1416 may comprise a sipe section substantially parallel to the Z-axis.

At least one sipe 1410 may comprise a first curvilinear portion 1418. At least one sipe 1410 may comprise a second curvilinear portion 1420. First curvilinear portion 1418 and second curvilinear portion 1420 may be oriented so as to form an S-shaped geometry.

In one embodiment, first curvilinear portion 1418 may communicate with ground-contacting surface directly. In one embodiment, second curvilinear portion 1420 may communicate with base 1408 directly.

At least one sipe 1410 may comprise lower vertical section 1422. Lower vertical section 1422 may contact base 1408. Lower vertical section 1422 may comprise a sipe section substantially parallel to the Z-axis.

FIG. 14 illustrates four independent radial sections of tread 1400. Namely, first section 1430, a second section 1432, a third section 1434, and a fourth section 1436. First section 1430 may be the radially outermost section, while fourth section 1436 may be the radially innermost section. First section 1430 may correspond to that section of tread 1400 including an upper vertical section (such as 1416). Second section 1432 may correspond to that section of tread 1400 including a first curvilinear portion (such as 1418). Third section 1434 may correspond to that section of tread 1400 including a second curvilinear portion (such as 1420). Fourth section 1436 may correspond to that section of tread 1400 including a lower vertical section (such as 1422).

In one embodiment, first curvilinear portion 1418 and second curvilinear portion 1420 of sipe 1410 may comprise a S-shaped geometry similar to a sinusoidal curve. The amplitude A2 of the curve in sipe 1410 may vary along the radial height of sipe 1410. The wavelength F3 of the curve in sipe 1410 may be constant along the height of sipe 1410. The wavelength F3 of the curve in sipe 1410 may alternatively vary along the height of sipe 1410. In one embodiment, a plurality of sipes 1410 may be contained within tread block 1402 or tread rib (not shown), and the curves of sipes 1410 may be in phase with one another. Alternatively, the curves of sipes 1410 may be out of phase with one another.

The amplitude A2 of the curve in sipe 1410 may decrease along the height of sipe 1410 as sipe 1410 extends radially inwardly into block 1402. The dashed lines representing the amplitude A2 of the curves of sipe 1410 at various positions along its radial height are inclined relative to the Z-axis by an inclination angle 12. Angle 12 may be between about 5 degrees and about 10 degrees. Angle 12 may be about 5 degrees. Angle 12 may be about 10 degrees. Angle 12 may be less than about 5 degrees and greater than about 10 degrees.

Stated differently, the amplitude A2 of sipe 1410 may decrease in value at a ratio of between about 1:12 and about 1:6 of the distance that sipe 1410 extends radially inwardly into block 1402 until amplitude A2 has a value of zero. Alternatively, the amplitude A2 of sipe 1410 may increase in value at a ratio of between about 1:12 and about 1:6 as sipe 1410 extends radially inwardly into block 1402.

Sipe 1410 may have a thickness T2. Thickness T2 may be defined as the distance between sipe sidewalls bounding sipe 1410, measured perpendicular to tangent lines taken at a radial height (measured along the Z-axis). Stated differently, thickness T2 is the thickness of sipe 1410 across sipe 1410, regardless of the angle of sipe 1410 at the point of measurement. Sipe 1410 may have a constant thickness T2 along its radial height.

With respect to tread 200 of FIG. 2, tread 300 of FIG. 3A, tread 1200 of FIG. 12, tread 1300 of FIG. 13, and tread 1400 of FIG. 14, the sipes illustrated in each embodiment, whether having a constant thickness, a varying thickness, a constant amplitude, a varying amplitude, a combination thereof, and the like, may maintain the illustrated arrangement as it extends into the tread block along the length of the tread block along the Y-axis. That is, for example, where a sipe has a varying thickness and a varying amplitude such as sipe 1310 of FIG. 13, it is understood that sipe 1310 may have that same varying thickness and amplitude at an interior portion of block 1306, perhaps near the center of block 1306 along the Y-axis. As such, while each of FIGS. 2, 3A, 12, 13, and 14 are elevational views, XZ-plane sectional views of the same sipes taken at a different point along the Y-axis would have the same varying or constant features, and inclination angles (12, where relevant), as the sipes illustrated in the elevational views.

In one embodiment, a tire is provided, the tire comprising: a tread portion comprising at least one of a tread block and a tread rib; at least one of the tread block and the tread rib having at least one sipe, wherein the at least one sipe includes at least one convex portion and at least one concave portion forming an S-shaped geometry along at least a portion of a length of the sipe, wherein the S-shaped geometry along at least a portion of the length of the sipe has an amplitude (A1), and wherein the amplitude (A1) varies along a radial height of the sipe, and wherein the at least one sipe includes a first curvilinear portion and a second curvilinear portion oriented substantially radially within the sipe, and forming an S-shaped geometry along the radial height of the sipe.

The S-shaped geometry along at least a portion of the length of the sipe may have a wavelength (F1), and the wavelength (F1) may be constant along a radial height of the sipe.

The amplitude (A1) of the S-shaped geometry along at least a portion of the length of the sipe may decrease as the sipe extends radially inwardly into the tread portion. The amplitude (A1) of the S-shaped geometry along at least a portion of the length of the sipe may decrease in value at a ratio of between about 1:12 and about 1:6 of a distance that the sipe extends radially inwardly into the tread portion.

The S-shaped geometry along the radial height of the sipe may have an amplitude (A2), and the amplitude (A2) may decrease as the sipe extends radially inwardly into the tread portion. The amplitude (A2) of the S-shaped geometry along the radial height of the sipe may decrease in value at a ratio of between about 1:12 and about 1:6 of a distance that the sipe extends radially inwardly into the tread portion.

The sipe may have a thickness (T2), and the thickness T2 may decrease as the sipe extends radially inwardly into the tread portion.

In another embodiment, a tire is provided, the tire comprising: a tread portion comprising at least one of a tread block and a tread rib; at least one of the tread block and the tread rib having at least one sipe, wherein the at least one sipe includes at least one convex portion and at least one concave portion forming an S-shaped geometry along at least a portion of a length of the sipe, wherein the S-shaped geometry along at least a portion of the length of the sipe has an amplitude (A1), wherein the at least one convex portion has a half-wavelength (F4) and wherein the at least one concave portion has a half-wavelength (F5), and wherein the half-wavelength (F4) of the at least one convex portion and the half-wavelength (F5) of the at least one concave portion vary along a radial height of the sipe, and wherein the at least one sipe includes a first curvilinear portion and a second curvilinear portion oriented substantially radially within the sipe, and forming an S-shaped geometry along the radial height of the sipe.

The amplitude (A1) may be constant along a radial height of the sipe.

The half-wavelength (F4) of the at least one convex portion may decrease as the sipe extends radially inwardly into the tread portion and the half-wavelength (F5) of the at least one concave portion may increase as the sipe extends radially inwardly into the tread portion. The half-wavelength (F4) of the at least one convex portion may decrease in value at a ratio of between about 1:12 and about 1:6 of a distance that the sipe extends radially inwardly into the tread portion and the half-wavelength (F5) of the at least one concave portion may increase in value at a ratio of between about 1:12 and about 1:6 of a distance that the sipe extends radially inwardly into the tread portion.

The S-shaped geometry along the radial height of the sipe may have an amplitude (A2), and the amplitude (A2) may decrease as the sipe extends radially inwardly into the tread portion. The amplitude (A2) of the S-shaped geometry along the radial height of the sipe may decrease in value at a ratio of between about 1:12 and about 1:6 of a distance that the sipe extends radially inwardly into the tread portion.

The sipe may have a thickness (T2), and the thickness T2 may decrease as the sipe extends radially inwardly into the tread portion.

In another embodiment, a tire is provided, the tire comprising: a tread portion comprising at least one of a tread block and a tread rib; at least one of the tread block and the tread rib having at least one sipe, wherein the at least one sipe includes a first curvilinear portion and a second curvilinear portion oriented substantially radially within the sipe, and forming an S-shaped geometry along the radial height of the sipe, wherein the S-shaped geometry along the radial height of the sipe has an amplitude (A2), and wherein the amplitude (A2) decreases as the sipe extends radially inwardly into the tread portion, and wherein the amplitude (A2) of the S-shaped geometry along the radial height of the sipe decreases in value at a ratio of between about 1:12 and about 1:6 of a distance that the sipe extends radially inwardly into the tread portion.

The at least one sipe may include at least one convex portion and at least one concave portion forming an S-shaped geometry along at least a portion of a length of the sipe, and the S-shaped geometry along at least a portion of the length of the sipe may have an amplitude (A1), and the amplitude (A1) may vary along a radial height of the sipe.

The amplitude (A1) of the S-shaped geometry along at least a portion of the length of the sipe may decrease in value at a ratio of between about 1:12 and about 1:6 of a distance that the sipe extends radially inwardly into the tread portion.

The at least one sipe may include at least one convex portion and at least one concave portion forming an S-shaped geometry along at least a portion of a length of the sipe, the at least one convex portion may have a half-wavelength (F4) and the at least one concave portion may have a half-wavelength (F5), wherein the half-wavelength (F4) of the at least one convex portion and the half-wavelength (F5) of the at least one concave portion vary along a radial height of the sipe. The half-wavelength (F4) of the at least one convex portion may decrease in value at a ratio of between about 1:12 and about 1:6 of a distance that the sipe extends radially inwardly into the tread portion and the half-wavelength (F5) of the at least one concave portion may increase in value at a ratio of between about 1:12 and about 1:6 of a distance that the sipe extends radially inwardly into the tread portion.

The sipe may have a thickness (T2), and the thickness T2 may decrease as the sipe extends radially inwardly into the tread portion.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11. Cartesian coordinates referenced herein are intended to comply with the SAE tire coordinate system.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A tire, comprising:
a tread portion comprising at least one of a tread block and a tread rib;
at least one of the tread block and the tread rib having at least one sipe,
wherein the at least one sipe includes at least one convex portion and at least one concave portion forming an S-shaped geometry along at least a portion of a length of the sipe,
wherein the S-shaped geometry along at least a portion of the length of the sipe has an amplitude (A1), and
wherein the amplitude (A1) varies along a radial height of the sipe, and
wherein the at least one sipe includes a first curvilinear portion and a second curvilinear portion oriented substantially radially within the sipe, and forming an S-shaped geometry along the radial height of the sipe.

2. The tire of claim 1, wherein the S-shaped geometry along at least a portion of the length of the sipe has a wavelength (F1), and wherein the wavelength (F1) is constant along a radial height of the sipe.

3. The tire of claim 1, wherein the amplitude (A1) of the S-shaped geometry along at least a portion of the length of the sipe decreases as the sipe extends radially inwardly into the tread portion.

4. The tire of claim 3, wherein the amplitude (A1) of the S-shaped geometry along at least a portion of the length of the sipe decreases in value at a ratio of between about 1:12 and about 1:6 of a distance that the sipe extends radially inwardly into the tread portion.

5. The tire of claim 1, wherein the S-shaped geometry along the radial height of the sipe has an amplitude (A2), and wherein the amplitude (A2) decreases as the sipe extends radially inwardly into the tread portion.

6. The tire of claim 5, wherein the amplitude (A2) of the S-shaped geometry along the radial height of the sipe decreases in value at a ratio of between about 1:12 and about 1:6 of a distance that the sipe extends radially inwardly into the tread portion.

7. The tire of claim 1, wherein the sipe has a thickness (T2), and wherein the thickness T2 decreases as the sipe extends radially inwardly into the tread portion.

8. A tire, comprising:
a tread portion comprising at least one of a tread block and a tread rib;
at least one of the tread block and the tread rib having at least one sipe,
wherein the at least one sipe includes at least one convex portion and at least one concave portion forming an S-shaped geometry along at least a portion of a length of the sipe,
wherein the S-shaped geometry along at least a portion of the length of the sipe has an amplitude (A1),
wherein the at least one convex portion has a half-wavelength (F4) and wherein the at least one concave portion has a half-wavelength (F5), and
wherein the half-wavelength (F4) of the at least one convex portion and the half-wavelength (F5) of the at least one concave portion vary along a radial height of the sipe, and
wherein the at least one sipe includes a first curvilinear portion and a second curvilinear portion oriented substantially radially within the sipe, and forming an S-shaped geometry along the radial height of the sipe.

9. The tire of claim 8, wherein the amplitude (A1) is constant along a radial height of the sipe.

10. The tire of claim 8, wherein the half-wavelength (F4) of the at least one convex portion decreases as the sipe extends radially inwardly into the tread portion and wherein the half-wavelength (F5) of the at least one concave portion increases as the sipe extends radially inwardly into the tread portion.

11. The tire of claim 10, wherein the half-wavelength (F4) of the at least one convex portion decreases in value at a ratio of between about 1:12 and about 1:6 of a distance that the sipe extends radially inwardly into the tread portion and wherein the half-wavelength (F5) of the at least one concave portion increases in value at a ratio of between about 1:12 and about 1:6 of a distance that the sipe extends radially inwardly into the tread portion.

12. The tire of claim 8, wherein the S-shaped geometry along the radial height of the sipe has an amplitude (A2), and wherein the amplitude (A2) decreases as the sipe extends radially inwardly into the tread portion.

13. The tire of claim 12, wherein the amplitude (A2) of the S-shaped geometry along the radial height of the sipe decreases in value at a ratio of between about 1:12 and about 1:6 of a distance that the sipe extends radially inwardly into the tread portion.

14. The tire of claim 8, wherein the sipe has a thickness (T2), and wherein the thickness T2 decreases as the sipe extends radially inwardly into the tread portion.

15. A tire, comprising:
a tread portion comprising at least one of a tread block and a tread rib;
at least one of the tread block and the tread rib having at least one sipe,
wherein the at least one sipe includes a first curvilinear portion and a second curvilinear portion oriented substantially radially within the sipe, and forming an S-shaped geometry along the radial height of the sipe,
wherein the S-shaped geometry along the radial height of the sipe has an amplitude (A2), and wherein the amplitude (A2) decreases as the sipe extends radially inwardly into the tread portion, and
wherein the amplitude (A2) of the S-shaped geometry along the radial height of the sipe decreases in value at a ratio of between about 1:12 and about 1:6 of a distance that the sipe extends radially inwardly into the tread portion.

16. The tire of claim 15, wherein the at least one sipe includes at least one convex portion and at least one concave portion forming an S-shaped geometry along at least a portion of a length of the sipe, wherein the S-shaped geometry along at least a portion of the length of the sipe has an amplitude (A1), and wherein the amplitude (A1) varies along a radial height of the sipe.

17. The tire of claim 16, wherein the amplitude (A1) of the S-shaped geometry along at least a portion of the length of the sipe decreases in value at a ratio of between about 1:12 and about 1:6 of a distance that the sipe extends radially inwardly into the tread portion.

18. The tire of claim 15, wherein the at least one sipe includes at least one convex portion and at least one concave portion forming an S-shaped geometry along at least a portion of a length of the sipe, wherein the at least one convex portion has a half-wavelength (F4) and wherein the at least one concave portion has a half-wavelength (F5), and wherein the half-wavelength (F4) of the at least one convex portion and the half-wavelength (F5) of the at least one concave portion vary along a radial height of the sipe.

19. The tire of claim 18, wherein the half-wavelength (F4) of the at least one convex portion decreases in value at a ratio of between about 1:12 and about 1:6 of a distance that the sipe extends radially inwardly into the tread portion and wherein the half-wavelength (F5) of the at least one concave portion increases in value at a ratio of between about 1:12 and about 1:6 of a distance that the sipe extends radially inwardly into the tread portion.

20. The tire of claim 15, wherein the sipe has a thickness (T2), and wherein the thickness T2 decreases as the sipe extends radially inwardly into the tread portion.
